(19) United States
(12) Patent Application Publication
(10) Pub. No.: US 2009/0138422 A1
(43) Pub. Date: May 28, 2009

(54) Methods for making collective decisions independent of irrelevant alternatives

(76) Inventor: Amir Hassan Ghaseminejad Tafreshi, North Vancouver (CA)

Correspondence Address: AMIR HASSAN, GHASEMINEJAD TAFRESHI, 260 MONTROYAL BLVD, NORTH VANCOUVER, BC, V7N 4E5, CA

(21) Appl. No.: 11/944,585

(22) Filed: Nov. 23, 2007

(51) Int. Cl. G06F 17/00

(52) U.S. Cl. 706/46

(57) ABSTRACT

Methods for making collective decisions independent of irrelevant alternatives. A preferred alternative found, using weighted preference lists while restricting the impact of spoilers, is considered as Independent Collective Choice. If a list is required, it is added to an ordered list of Independent Collective Choices and removed from weighted lists, and finding, adding, and removing are repeated. When selection of a plurality of alternatives with proportional representation is required, the lowest ranked alternative in an Independent Collective Choice Ordered List is removed to find the alternatives with predetermined quota. Some embodiments apply collective choice procedures repeatedly to select the highest ranked alternative, compare the outcomes before and after the removal of alternative combinations, and use the selection of Independent Collective Choice recursively and iteratively when selecting highest or lowest ranked alternatives. Various embodiments can be in decision making systems including humans and machines for selection, sorting, and prediction problems.

### BACKGROUND OF THE INVENTION

1. Field of Invention

This invention relates generally to decision making based on preferences generated by humans or non-humans. More specifically the present invention relates to methods for making collective decisions, with and without proportional representation that prevents some decision making flaws and encourages the sincere expression of preferences averting the impact of irrelevant alternatives.

2. Related Art

Decision making is part of our everyday lives, we make personal decisions and also we make collective decisions. Each one of us has different understanding about the world but we make decisions that are about all of us collectively.

Decisions people make when they vote for their favorite artist in televised entertainment programs, in teams, in groups, in boards of directors, shareholder assemblies and in parliaments as well as electing the prime ministers and presidents are examples of collective decisions that we make.

Also many collective decisions are made in the systems that are made by humans for example automatic control systems in factories and computer networks are making millions of collective decisions everyday. These systems are made of processing units that get information from different sensors about the pressure, temperature and thresholds, and based on these readings choose one of many possible actions to be performed. To avoid having single points of failure, we design systems that have redundancy and each measurement is done and processed by multiple controllers and in these situations the aggregate decision based on the recommendations by a plurality of controllers is required.

We also make decision with our machines, Group Decision Support Systems and Executive Decision Support Systems to make better decisions. We use computerized voting and vote aggregation systems. We use automated systems that get input from other devices and humans and help us in making decisions or make decisions themselves. Many of the automatic devices made by modern technology make decisions based on the multiple inputs from evaluators to the device. Such decisions can include, among others: when a choice must be made based on the results observed by many sensors in control systems; or what decision should be made based on the trend information and expert advice in advertising and budgeting, when deciding about what information to be shown to, or recorded for, the users; When doing assessments or evaluations in the context in which the device is being used; or when predicting about a system that a device attempts to model.

When the decisions are made by more than one evaluator, either a human evaluator or automated evaluator, like a machine or a program, it is necessary to aggregate the decisions and decide about what is the best collective choice based on the preferences of evaluators.

The choice set for an individual is defined as his or her selection of the most preferred from a set of alternatives. The individual's preference between alternatives is itself the result of the aggregation of a variety of different considerations. Collective Choice is about the possibility of combining individual's preferences to find a collective choice set from a set of alternatives. Kenneth Arrow in his Impossibility Theorem questions whether it is possible to find a method that combines individual's preferences and says that no voting system based on ranked preferences can meet a specific set of seemingly reasonable criteria when there are three or more alternatives. In second half of the past century many scholars have shown that social choice is in fact possible. Amartya Sen, in his Nobel lecture, The Possibility of Social Choice, argues that, “Impossibility results in social choice theory have often been interpreted as being thoroughly destructive of the possibility of reasoned and democratic social choice, including welfare economics. I have argued against that view. Indeed, Arrow's powerful Impossibility Theorem invites engagement, rather than resignation. Inconsistencies arise more readily in some situations than in others, and it is possible to identify the situational differences.” (Sen 1999).

Let's assume that a company in ideal condition has to make a decision about an advertising expense. 33% of executive decision makers like to spend amount $10000, 31% of them like to spend amount $20000 and 36% of them believe that this expense is not necessary at all. The first and second group can not agree on a compromise about the amount. It is obvious that the last option is not what the people prefer since 64% agree on this expense but if they use “First Past The Post voting system”, they will not advertise. The observation in this example is a well known and well documented flaw in Plurality because it ignores a lot of information that can be collected about voters' preferences (Saari 2001). It happens with more than two alternatives and is called Vote Splitting or Spoiler Effect. In elections “Ever since it became common for more than two candidates to contest a seat, it has been obvious that simply to declare the candidate having the highest number of votes may grossly misrepresent the wishes of the voters” (Lakeman 1974). Therefore, in many aggregation systems, human decisions are affected by the possibility of vote splitting and spoiler effect and people are shifted toward tactical voting which in turn leads to non-optimal collective decisions.

Relative majority or plurality voting system is based on asking only about the most preferred alternative from the participants and ignores a lot of information about second, third, . . . and last voter preferences that can be collected and therefore, although it is being widely used all over the world, it has many known weaknesses. Other vote aggregation systems ask for a preference list from the participants that are either just sorted or are prioritized by a numeric weight assigned to them. Unfortunately, these systems also have well known problems.

One of the fields where selection from multiple alternatives is important is policy making. Robert Dahl says: The only rule compatible with decision-making in populist democracy is the majority principle. (Dahl 2006). Which he defines as: In choosing among alternatives, the alternative preferred by the greater number is selected. Dahl says: “In order for x to be government policy it is a necessary and sufficient condition that for every other alternative, the number who prefer x to the alternative is greater than the number who prefer the alternative to x” (Robert Dahl, 1956); unfortunately, finding such an alternative is not easy.

Many voting systems have been proposed for choosing the collective choice from individual preferences including but not limited to: Relative Majority (Plurality), Pair wise ranked winner, Borda Count, Run-off Voting and Instant Run-off Voting (IRV). Each one of existing collective choice procedures come in different varieties and the list of them and their similarities and differences are long and are discussed in many books and papers. In this description only examples of each group are mentioned. When the number of alternatives is two, the result of using most of these voting systems is similar but when the number of alternatives is more than two then their results may be different.

When a large group of the voters are confronted by only two alternatives, except in rare cases, they will come together into a majority. Most of the problems arise in a context of more than two alternatives. Although 51% is not a strong majority, when none of the preference lists gets a decisive majority of 51%, the majority and therefore the public choice is not clear. One solution is simply choosing the relative majority (plurality) when decisive majority is not available.

Let's look at the following examples where most of prior collective decision making procedures are able to choose the best choice.

If the grouped preferences of the evaluators between two candidates, Andrew and Brian, are as shown in the following list:

### 55 Andrew>Brian

### 45 Brian>Andrew

The number in front of each preference list is the weight, the count or relative frequency of evaluators with that preference, and the sign “>” means that Andrew is preferred over Brian and so the first line means that a group of evaluators with a combined weight of 55, prefer Andrew over Brian. There is no ambiguity about the collective choice and various voting systems including Relative Majority, IRV, Ranked pairs, Borda Count all select Andrew.

If alternative Chris is introduced and the grouped preferences between Andrew and Brian and Chris are as shown in the following list:

### 55 Andrew>Brian>Chris

### 20 Brian>Chris>Andrew

### 25 Brian>Andrew>Chris

There is no ambiguity about the collective choice and various voting systems including Relative Majority, IRV, Ranked pairs, Borda Count all select Andrew.

If the grouped preferences of evaluators between Andrew and Brian and Chris are as shown in the following list:

### 45 Andrew>Brian>Chris

### 18 Brian>Chris>Andrew

### 27 Brian>Andrew>Chris

### 10 Chris>Andrew>Brian

Although there is ambiguity about the choice because no first option has the support of more than half of the evaluators, but the result is decisive. Various voting systems including Relative Majority, IRV, Ranked pairs, Borda Count all select Andrew.

However, the result of the decision can easily be manipulated by introduction of an alternative like Chris if it is favored by some of those who prefer the majority winner. If the preferences of evaluators between two alternatives Andrew and Brian are as shown in the following list:

### 60 Andrew>Brian

### 40 Brian>Andrew

And Chris is introduced:

### 32 Chris>Andrew>Brian

### 28 Andrew>Brian>Chris

### 40 Brian>Chris>Andrew

Various voting systems including Relative Majority, IRV, Ranked pairs, Borda Count all select Brian. The introduction of Chris didn't cause Chris to be elected but it changed the collective choice. The introduction of Chris shouldn't have any impact on selection between Andrew and Brian, but it does change the outcome. Alternative Chris is an example of an irrelevant alternative that is a spoiler.

This is the result of the fact that most of the voting systems including ordinal and preferential voting systems do not satisfy the condition of “Independence of Irrelevant Alternatives”. None of the Borda count, IRV, Kemeny-Young, Minimax, Plurality, Ranked Pairs, Runoff voting, and Schulze collective choice procedures satisfies this condition. In the context of our above example this results in the selection of Brian over Andrew. This is a problem because Chris is not being selected but changes the selection between Andrew and Brian.

In Plurality systems, IRV, and Ranked Pairs, one way the people who prefer (Chris>Andrew>Brian) and prefer Andrew over Brian (as the majority in this case) could maximize their utility is by insincere voting using Compromise Strategy of voting for Andrew above Chris even if they prefer Chris to Andrew (voting Andrew>Chris>Brian instead of Chris>Andrew>Brian). Otherwise, not only their preferred choice Chris is not selected but also their second choice Andrew does not have a chance too, but to use this strategy they need to know beforehand that Chris doesn't have a chance.

Even machine decisions based on preferential voting techniques like the method and apparatus proposed in U.S. Pat. No. 6,763,338 to Kirshenbaum, Jul. 13, 2004 are susceptible to the problems mentioned above. For example, the content of table 420 of FIG. 4 (b) of above mentioned patent it is shown as the following Weighted Preference Lists (WPL):

### 1 Sushi>Pizza>Burger>Salad

### 2 Salad>Burger>Pizza>Sushi

### 1 Pizza>Salad>Sushi>Burger

### 1 Sushi>Burger>Pizza>Salad

And in the description of above mentioned patent, it is discussed that the method proposed has different results depending to the type of preferential voting technique used. Moreover, it can be shown that even using one preferential voting technique in Kirshenbaum's invention will result in different decisions by introduction of irrelevant alternatives. The description explains that when alternatives with “Most Last Place Preferences” are removed repeatedly, “Burger” is selected as the aggregate decision.

But if another type of restaurant, for example “Sub”, is introduced and most of people don't prefer it as shown below:

### 1 Sushi>Pizza>Burger>Salad>Sub

### 2 Salad>Burger>Sub>Pizza>Sushi

### 1 Pizza>Salad>Sushi>Sub>Burger

### 1 Sushi>Burger>Pizza>Sub>Salad

Sushi will be removed first; Then Pizza and then Sub will be removed. This will lead to

### 1 Burger>Salad

### 2 Salad>Burger

### 1 Salad>Burger

### 1 Burger>Salad

And “Salad” will be selected as the aggregate decision while introduction of Sub should not switch the choice between Burger and Salad.

Another difficulty in collective decision making is when proportional representation is desired in decision when more than one alternative should be selected. If the grouped preferences of the evaluators between three alternatives (A), (B) and (C) are as shown in the following list, and in the context of a decision two alternatives should be selected.

### 59 A>C>B

### 16 B>A>C

### 25 B>C>A

It is certain that the first list has a clear majority but selecting (A) and (C) based on the preferences of majority means ignoring the preferences of 41% of evaluators that have (B) as their preference. In many occasions, whenever possible we want to select the collective choice set so that it proportionally represents the preferences. However, this is not always an easy task, for example:

If the preference lists of the evaluators after introduction of (D) is according to the following lists:

### 59 A>C>B>D

### 16 B>A>C>D

### 25 D>B>C>A

And if in the context of a decision, two alternatives should be selected, it is not clear what the second choice should be.

Many Proportional Voting Systems have been proposed but most of them have a similar problem. For example, Single Transferable Vote chooses (C) as the second alternative because (B) has the fewest top preferences. In fact (D) is preventing (B) to be selected even though it has no chance to be elected under this collective choice procedure.

### BRIEF SUMMARY OF THE INVENTION

The embodiments of present invention provide solutions to the problems identified above by selecting the alternatives after the impact of spoilers are restricted. According to the invention, a spoiler in a collective choice procedure is considered a combination of one or more alternatives that none are the collective choice among a number of alternatives but after their removal, individually or together, from Weighted Preference Lists (WPL), change the collective choice found by the same procedure. One type of spoiler is a group of alternatives that have spoiler effect when removed together and, hereafter, is called “compound spoiler”.

Some embodiments of this invention process the preferences expressed by evaluators and avert the impact of spoilers on each round of alternative selection during a decision making process. Some of the embodiments identify the spoilers according to the definition mentioned above and temporarily exclude them from the decision in each step. Some embodiments iteratively and recursively use the invention to make sure that the ripple effects of spoilers on decision are averted.

Some embodiments of this invention select a single alternative or an ordered list of alternatives by restricting the impact of spoilers and constructing a majority based on collective choice procedures without considering proportionality (which will be referred to hereafter as “Collaborative Plurality Methods”). When a number of alternatives should be selected, some embodiments select a Proportional Collective Choice Set from alternatives in a given set of Weighted Preference Lists with proportional representation while restricting the impact of spoilers (which will be referred to hereafter as “Collaborative Proportional Contribution Methods”). Some embodiments of “Collaborative Proportional Contribution Methods” may use “Collaborative Plurality Methods” while deciding which alternative should be temporarily ignored in each round of selection. This collaborative approach is not only averting the impact of irrelevant alternatives on the collective choice but also can prevent the true expression of preferences by the evaluators to become self defeating.

The embodiments of this invention in control systems will be able to make better decisions. And when this invention is used in group decision making, the voters will be able to sincerely express their preferences without worrying about that by this expression they may be helping an outcome they don't prefer. As a result when applied to group decision making and elections the embodiments of this invention will encourage sincerity and reduce the necessity for tactical voting.

When this invention is applied to different collective choice procedures on the same weighted preference lists at many situations the results provided are identical. This means that, in many cases the result of using the embodiments of this invention is less dependent to the collective choice procedure used in the embodiment.

Some embodiments can be applied to classification, selection and prediction problems. Various embodiments may use plurality, other voting techniques or collective choice procedures; some may apply this invention in manual or automatic tallying, vote calculation and, decision making systems, group decision support system, executive decision support systems. The embodiments of this invention can be, among many others, in methods, means, apparatuses, and software programs or embedded programs in hardware devices where a decision on a number of alternatives based on a plurality of inputs are made.

### BRIEF DESCRIPTION OF THE DRAWINGS

The drawings show example embodiments of the invention, and give examples of using the invention. The objects, features and advantages of the invention are more than those that are mentioned in the description and will become more apparent to those skilled in the art from the following detailed description, when read in conjunction with the accompanying drawings, wherein:

FIG. 1a is a flowchart showing the basic steps performed, in some embodiments of the invention, to produce an Independent Collective Choice Ordered List or an Independent Collective Choice using a given set of Weighted Preference Lists.

FIG. 1b is a flowchart showing the basic steps performed, in some embodiments of the invention, to produce an Independent Collective Choice Ordered List or an Independent Collective Choice using a given set of Weighted Preference Lists with early majority detection.

FIG. 2a is a flowchart showing the basic steps performed, in some embodiments of the invention, to find a preferred collective choice using given Weighted Preference Lists while restricting the impact of spoilers.

FIG. 2b is a flowchart showing the basic steps performed, in some embodiments of the invention, to find a preferred collective choice using given Weighted Preference Lists while restricting the impact of spoilers, using steps to produce an Independent Collective Choice Ordered List when deciding which spoilers should be signed out.

FIG. 2c is a flowchart showing the basic steps performed, in some embodiments of the invention, to find a preferred collective choice using given Weighted Preference Lists while restricting the impact of spoilers, making a ranked List of Spoilers when deciding which spoilers should be signed out.

FIG. 2d is a flowchart showing the basic steps performed, in some embodiments of the invention, to find a preferred collective choice using given Weighted Preference Lists while restricting the impact of spoilers further including an early termination option.

FIG. 3a is a flowchart showing the basic steps performed, in some embodiments of the invention, to find the highest ranked alternative as well as to make a ranked list of alternatives applying a collective choice procedure repeatedly.

FIG. 3b is a flowchart showing the basic steps performed, in some embodiments of the invention, to find the highest ranked alternative as well as to make a ranked list of alternatives applying a plurality method repeatedly.

FIG. 4 is a flowchart showing the basic steps performed, in some embodiments of the invention, to create a List of Spoilers using given Weighted Preference Lists.

FIG. 5a is a flowchart showing the basic steps performed, in some embodiments of the invention, to find a preferred collective choice using a replica of given Weighted Preference Lists while restricting the impact of spoilers.

FIG. 5b is a flowchart showing the basic steps performed, in some embodiments of the invention, to find a preferred collective choice using a replica of given Weighted Preference Lists, while restricting the impact of spoilers, recursively performing the steps to produce an Independent Collective Choice Ordered List of Spoilers, when deciding which spoilers should be removed.

FIG. 5c is a flowchart showing the basic steps performed, in some embodiments of the invention, to find a preferred collective choice using a replica of given Weighted Preference Lists while restricting the impact of spoilers, making a ranked List of Spoilers when deciding which spoilers should be removed.

FIG. 6 is a flowchart showing the basic steps performed, in some embodiments of the invention, to create a List of Spoilers using a supplied set of Weighted Preference Lists.

FIG. 7 is a flowchart showing the basic steps if performed, in some embodiments of the invention, to select a collective choice set from alternatives in a set of Weighted Preference Lists with proportional representation.

### DETAILED DESCRIPTION OF SOME OF THE EMBODIMENTS

The descriptions and discussions herein illustrate technologies related to the invention, show examples of the invention and give examples of using the invention. Known methods, procedures, systems or components may be discussed without giving details, so as to avoid obscuring the principles of the invention. On the other hand, numerous details of specific examples of the invention may be described, even though such details may not apply to other embodiments of the invention. Details are included and omitted so as to better explain the invention and so as to aid in understanding the invention.

The invention is not to be understood as being limited to or defined by what is discussed herein; rather, the invention may be practiced without the specific details described herein. One skilled in the art will realize that numerous modifications, variations, selections among alternatives, changes in form, and improvements can be made without departing from the principles, intention or legal scope of the invention.

Some descriptions herein use abstract or general terms including among others: symbol, frequency, Relative frequency, number, process, procedure, or step. Those skilled in the art use such terms as a convenient nomenclature for manual and automated procedures, data and operations within a computer, digital device or electromechanical system. Such data and operations are represented by physical properties of actual objects including electronic voltage, magnetic field, optical reflectivity or other properties. Similarly, perceptive or mental terms including, among others, detect, sense, recall, present, compare, process, manipulate, analyze, decide or determine, may also refer to such data, such operations or to manipulations of such physical properties.

Embodiments of this invention use a set of Weighted Preference Lists to make collective decisions. A decision is presented as selecting one or more alternatives from a set of alternatives. The decision is an attempt to pick, among many possible examples, the alternatives that maximize, minimize, or optimize an outcome or utility, best match, apply to, relate to, are relevant for, correspond to or are appropriate and may be part of, among many other things, a personal decision support system, an executive decision support system, a group decision support system or an election system.

The collective decision sometimes is choosing a single alternative and sometimes is choosing a number of alternatives among the possible alternatives. In this description, when the decision is about choosing a single alternative, the result is called a collective choice and when it is about choosing a number of alternatives among the possible alternatives, the result is called a collective choice set. When the collective choice set is sorted according to collective preference, the result is called collective choice ordered list. When a number of alternatives are selected in a way that they represent the proportions of the preferences of evaluators about the alternatives, the result is called Proportional Collective Choice Set.

Each Weighted Preference List is a ranked list of a set of alternatives with a weight attached to the list. Each ranked alternative may have an ordinal scale or score number attached to that alternative

Each Weighted Preference List may be, but is not limited to, a grouping of identical preferences of a plurality of evaluators about a set of sorted or scored alternatives, or a ranking of preferences by an evaluator about a set of sorted or scored alternatives.

The preferences may be collected in many different ways or from different sources including but not limited to: surveys, polls, studies, elections, data acquisition systems, voting, signals arriving, group discussions, data in databases and data warehouses, surveillance, experiments, observations.

Some embodiments let a number of alternatives be on a Weighted Preference List and some may require all of the alternatives be on Weighted Preference Lists. Some embodiments of this invention may require the number of alternatives in the lists be the same which means every evaluator must include the same number of alternatives in his/her/its evaluation, other embodiments may allow the number of alternatives in Weighted Preference Lists be different which means that evaluators may just express their evaluations about a subset of alternatives.

When short lists are allowed, some embodiments may consider the highest ranked alternative in all lists with same weight, which means all not mentioned alternatives being considered below the last mentioned alternative. Some embodiments may penalize those who have voted for less number of alternatives by considering their least favored alternative at the level of least favored alternatives of complete preference lists.

Some embodiments of this invention may allow a score be attached to the alternatives in a list, and other embodiments may just accept a ranking of alternatives on an ordinal scale. Some embodiments of this invention may require the rank, score or ordinal scale assigned to alternatives to be unique for every alternative in each list, and other embodiments may allow the ranking, score or ordinal scale to be similar for some alternatives in the each list that indicates that the evaluators with that preference list are indifferent when comparing those alternatives. Some embodiments may allow the evaluators to rank some alternatives at the top and some alternatives at the bottom of their preference and will consider all the not mentioned alternatives with equal score or ranking in the middle.

Different embodiments of the invention may store the lists on different media including but not limited to: on paper, on volatile or non-volatile electronic memory, magnetic or optical storage devices. The lists may be organized in many different ways including but not limited to spread sheets, tables, charts, databases, data warehouses, files, trees, graphs, networks. The flowcharts and the methods of the invention may be performed by humans or by electronic machines.

The weight is a number assigned to each Weighted Preference List. It may be, but is not limited to, the count, vote count, frequency, relative frequency of evaluators having same preference, or a presentation of power, privilege, trust, significance, confidence, reliability, expertise of each evaluator or a group of evaluators having same preferences. It may also be, but is not limited to, a result of combining the count, vote count, frequency, relative frequency, power, privilege, trust, significance, confidence, reliability and expertise of evaluators having same preferences.

The weight may be the result of calculations by giving all the evaluators equal or different power and in the later case it may be a presentation of a point system that presents among many possibilities the confidence or importance of the evaluator.

Weighted Preference Lists may be made from similar individual preferences. For example, if John prefers “Page A” of a website over “Page B”, and “Page B” over “page C”, and Mary and Mark have the same preference, but Andrew prefers “Page B” of a website over “Page A”, and “Page A” over “Page C”. The preference of John, Mary and Mark are listed together with a count or frequency of three and the preference of Andrew is in another list with a frequency or count of one, as shown in the following list:

### 3 A>B>C

### 1 B>A>C

The same Weighted Preference Lists can be presented by their percentage or relative frequency, as shown in the following list:

### 75 A>B>C

### 25 B>C>A

In this example there are 4 evaluators, three alternatives, and there are two lists in presented Weighted Preference Lists. Different embodiments of this invention may also use many other ways of the presentation of the relative prevalence of the preferences.

Weighted Preference Lists may be made manually by grouping similar preferences and counting them or can be done automatically using machines.

The evaluators may be a plurality of humans, non-human means of evaluation, or a mix of humans with non-humans. The evaluator may be, among many other things; people, machines with or without artificial intelligence, sensors, signals, programs or the programs' output or state, or observed attributes or behaviors.

Each evaluator may express his/her/its preferences about some alternatives, among many different ways, by ranking or rating a number of alternatives, behaving differently related to different alternatives, or having different attributes at different levels, or show different attitude toward different alternatives.

An alternative may be, among many other things, a value, a candidate or person, an opinion, a prediction, an attribute, an option, a behavior, a category, an advertisement, an entertainment selection, a document, place, a product, a thing or information, an action to be performed, a set of values, a range of numeric values, a group of attributes, a classification of objects, a category, a set of measurements, a future behavior, a set of future behaviors, a set of options, a set of predictions, a set of candidates, a set of products, a set of objects, a set of solutions for problems, a set of observations, a set of controllable parameters, and a set of data collected from a group of sensors or their combinations.

In this invention, a spoiler in a collective choice procedure is considered a combination of one or more alternatives that none are the collective choice, but their removal, individually or together, from Weighted Preference Lists, affects the collective choice selected by the same procedure. A group of alternatives that have spoiler effect when removed together is called “compound spoiler”.

A collective choice or a collective choice ordered list or a Proportional Collective Choice Set is considered independent if it is decided by one of the embodiments of this invention in which the process is designed to evade the dependency of the outcome to the removal of unselected alternatives from Weighted Preference Lists.

When making decisions about alternatives or while ranking alternatives, depending on the type of collective choice procedure used, a condition of tie may arise. For example, when using plurality to choose the highest ranking alternative in the following Weighted Preference Lists:

### 22 A>B>C

### 39 B>A>C

### 39 C>A>B

B and C are tied for being the highest ranked alternative since both are the top choice for 39 evaluators.

In such cases, some embodiments of this invention use the pair wise comparison of the tied alternatives if they are only two, or Ranked Pairs or Schulze method if the tie is between more than two alternatives. Some embodiments use scoring collective decision making procedures like Borda Count just to break the tie. Some embodiments may determine and declare these alternative collective choice procedures ahead of the preference collection phase to prevent any possibility of manipulation (by changing the procedure) after the results are gathered. Some may keep these procedures concealed to prevent tactical voting.

Sometimes in situations like the following example, the two alternatives are considered tied in many collective choice procedures.

### 10 A>C>B

### 10 B>A>C

### 10 C>B>A

In such a symmetrical situation, in some embodiments the tie can be broken by randomly selecting one of the tied alternatives or even going back to the evaluators and asking about their preferences about the tied alternatives. Sometimes it is also possible to accept all of the tied alternatives.

In the following description, the examples show the situations where many existing collective decision making methods have difficulty or are prone to instability and sensitivity to manipulation of decision outcome and embodiments of this invention are evading those flaws.

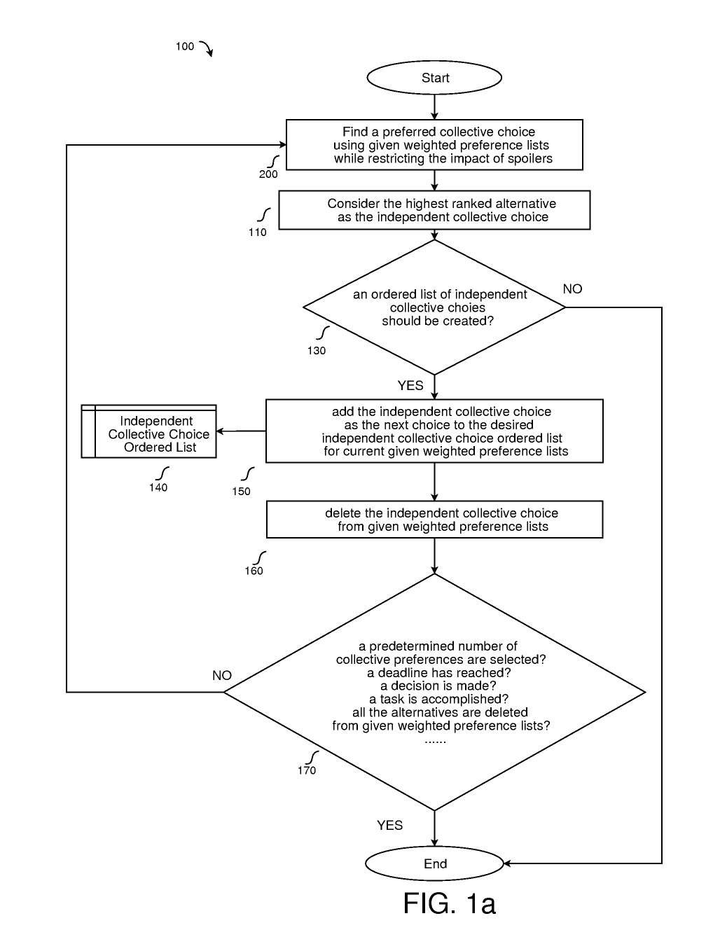

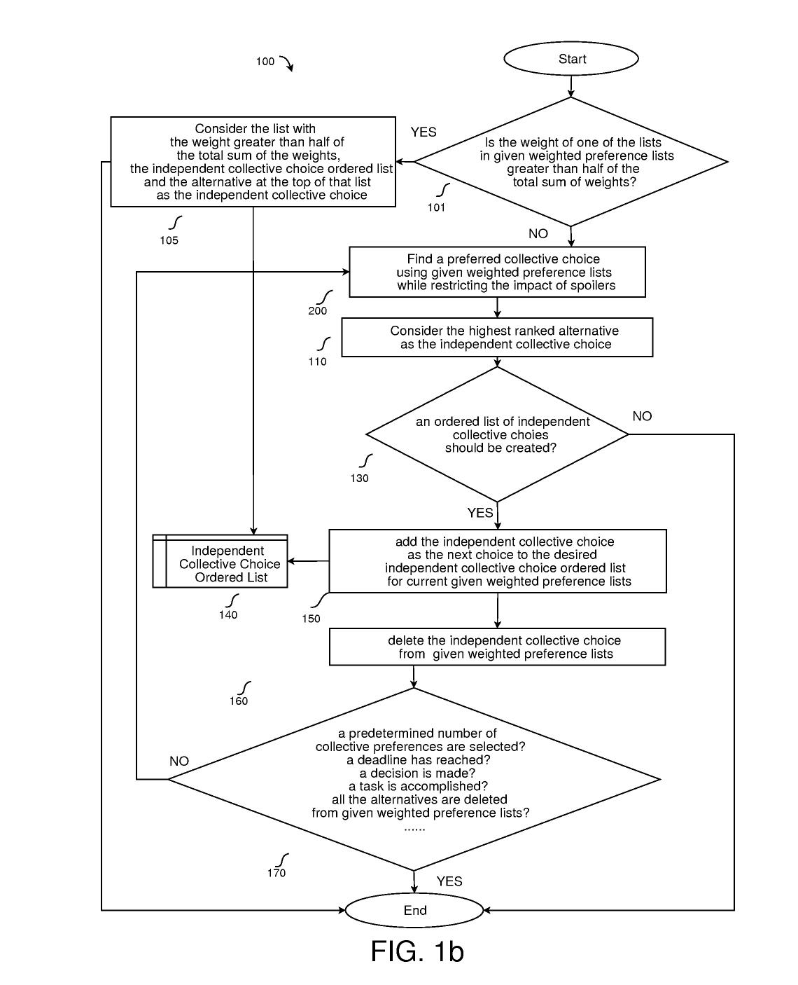

FIG. 1a is a flow chart showing the basic steps used in process 100, according to some embodiments of the invention. It finds an Independent Collective Choice or produce an Independent Collective Choice Ordered List using a given set of Weighted Preference Lists.

In step 200, a preferred collective choice is found based on the information in a given set of Weighted Preference Lists while restricting the impact of combinations of one or more alternatives that none are the collective choice among a number of alternatives but after their removal, individually or together, from Weighted Preference Lists, change collective choice found by the same procedure. This is a Collaborative Plurality Method because the evaluators are not insisting on their topmost choices and not only averts the impact of irrelevant alternatives on the collective choice but also prevents true expression of preferences by the evaluators to become self defeating. In step 110, the Independent Collective Choice is considered to be the highest ranked alternative that was just found in step 200.

In step 130, if an ordered list of Independent Collective Choices should not be created the decision process is concluded and said independent collective choice is decision outcome. This results a quick end for those situations that only a single alternative is desired to be selected as the collective choice. This may be used in elections in single-member district electoral systems.

If an ordered list of Independent Collective Choices should be created, in step 150, the Independent Collective Choice just selected is added to a list that is called the Independent Collective Choice Ordered List shown as list 140.

In step 160, the Independent Collective Choice is deleted from Weighted Preference Lists.

In step 170, a decision is made to continue finding other alternatives to be added to Independent Collective Choice Ordered List based on some criteria including, but not limited to: If a predetermined number of collective preferences are selected, a deadline has passed or if based on the information processed so far, a decision is made or a task is accomplished, or if all the alternatives have been deleted from the Weighted Preference Lists.

If the process should be continued, steps 200 to 170 are repeated using the Weighted Preference Lists with remaining alternatives.

### Example 1

### An Embodiment in the Context of Deciding about the Production of a Drug

Let's assume 100 researchers have expressed their preferences about production of three drugs for a disease. Each drug has benefits and side effects and different researchers have different preferences. Also let's assume that environmental circumstances dictate that only one of the drugs can be mass produced and we want to use the plurality method for choosing the collective choice. However, we also want to know in case that the production of the most preferred collective choice became impossible what are the second and third preferred alternatives.

The preferences about Drugs A, B and C are collected and aggregated to a set given WPL (Weighted Preference Lists) shown below:

The number in front of each preference list is the weight of that preference list which in this case is the count of the researchers having that preference.

### Given WPL:

### 40 B>C>A

### 32 C>A>B

### 28 A>B>C

Although 60 researchers prefer Drug A over B, but the introduction of Drug C does change the outcome. Many voting systems are prone to this flaw and say B is the collective choice. Plurality, IRV, Ranked pairs, and Borda Count all select (B).

Applying process 100, using the plurality method which looks only at the first choice in preference lists, Step 200 analyzes that “Drug B” would be selected, but if “Drug C” is removed from Weighted Preference Lists then “Drug A” will be the collective choice. Sixty people prefer “Drug A” to “Drug B” but the introduction “Drug C” splits their vote and “Drug B” is chosen as a result. Here “Drug C” is considered to be the spoiler. Drugs A and B don't have this property. If “Drug A” is removed “Drug B” will be selected with even more preferences (no change in the outcome) and “Drug B” itself is not considered a spoiler based on the definition above. Step 200 will process the given lists without “Drug C” to restrict the impact of the spoiler:

Given WPL, without C:

### 40 B>A

### 32 A>B

### 28 A>B

And the highest ranked alternative will be determined to be:
Highest ranked alternative: A

In step 110, “Drug A” will be selected as the Independent Collective Choice.

In step 130, If only one Independent Collective Choice should be selected, “Drug A” will be the desired answer but in this example an ordered list of collective choices is desired; therefore, step 150 will be the next step.

In step 150, “Drug A” will be added to the Independent Collective Choice Ordered List shown as 140.

In step 160, “Drug A” will be deleted from Weighted Preference Lists resulting WPL shown below:

### Given WPL, A Deleted:

### 40 B>C

### 32 C>B

### 28 B>C

In step 170, it is decided that more alternatives must be selected and in step 200, Weighted Preference Lists shown in WPL will be used but there can not be any spoilers between two alternatives B and C, which will result in a highest ranked alternative as:

Highest ranked alternative: B

In step 110, B is selected as an Independent Collective Choice and in step 150, B will be add as the next choice to Independent Collective Choice Ordered List 140, which results:

### Independent Collective Choice Ordered List: (A>B)

In step 160, B is deleted from given Weighted Preference Lists resulting WPL shown below:

### Given WPL, B Deleted:

### 40 C

### 32 C

### 28 C

In step 170, it is decided that more alternatives must be selected. In steps 200 and 110 to 160, C will be selected as Independent Collective Choice and will be added as the next choice to Independent Collective Choice Ordered List.

### Independent Collective Choice Ordered List: (A>B>C)

This means that the best collective choice is the production of “Drug A” and the next choice is “Drug B”. “Drug A” is called the Independent Collective Choice because the embodiments of this invention using plurality method would choose “Drug A” if choice “Drug C” was not introduced as an alternative and will choose “Drug A” if “Drug C” is introduced as an alternative.

The embodiments of this invention make the same decision before and after introduction of an alternative except in situations like when the introduced alternative is so preferred that it becomes the collective choice itself.

Step 200 can be done differently in different embodiments of this invention. Different embodiment of this invention can use different collective choice procedures while finding the highest ranked alternative. For the example above, embodiments of this invention using any of plurality, Ranked pairs, or Borda count all will choose (A>B>C) as Independent Collective Choice Ordered List after they restrict the impact of the spoilers.

FIG. 1b is a flow chart showing the basic steps used in process 100, according to some embodiments of the invention. It finds an Independent Collective Choice or produces an Independent Collective Choice Ordered List using a given set of Weighted Preference Lists.

In step 101, if the weight of one of the lists in given Weighted Preference Lists, is greater than half of the total sum of weights of said given Weighted Preference Lists, in step 105, the alternative at the top of that list is considered the Independent Collective Choice and that list is considered the Independent Collective Choice Ordered List and is copied to list 140 and the process 100 is concluded. If the weight of none of the lists is greater than half of the total sum of weights, step 200 is performed. The rest of FIG. 1b is exactly as FIG. 1a described above.

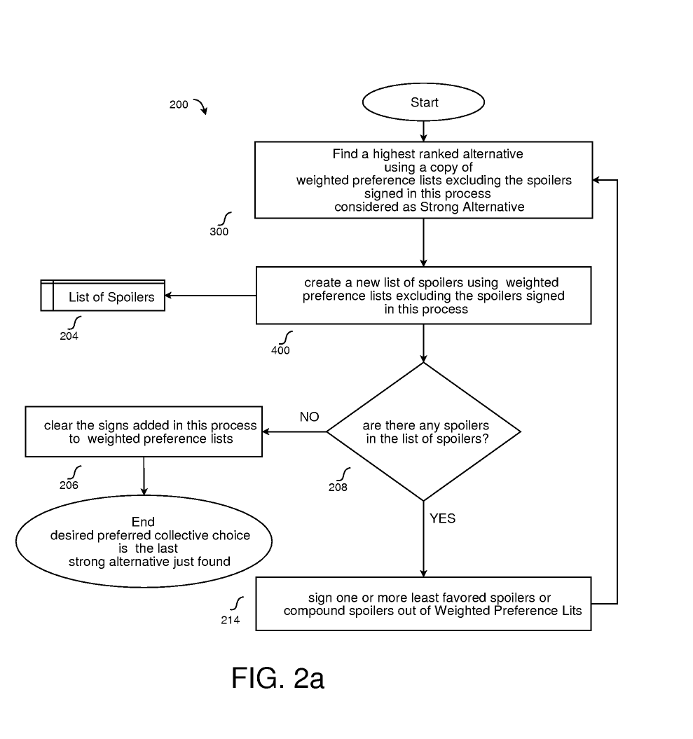

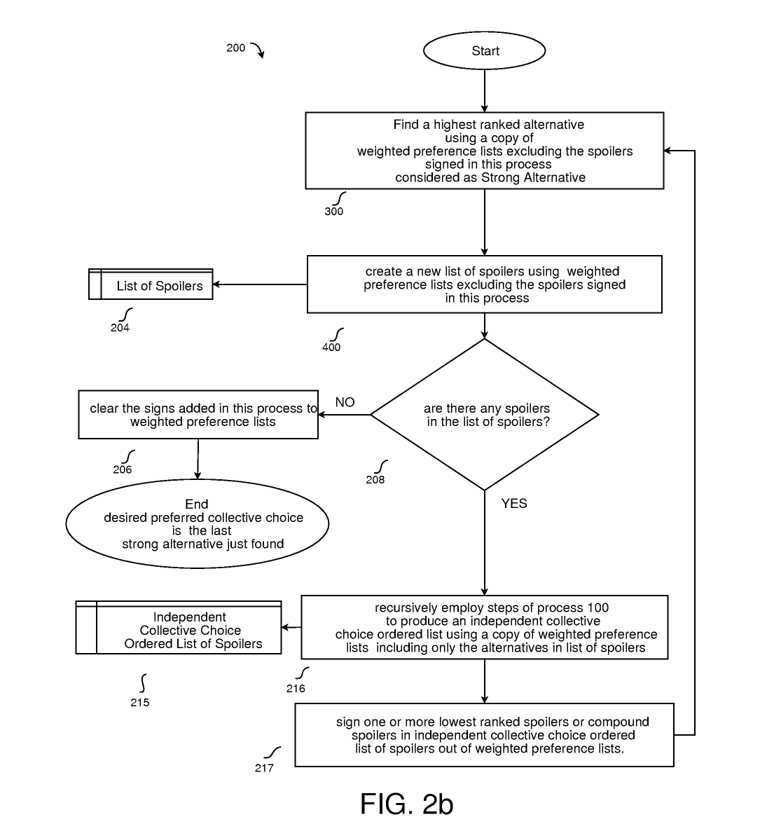

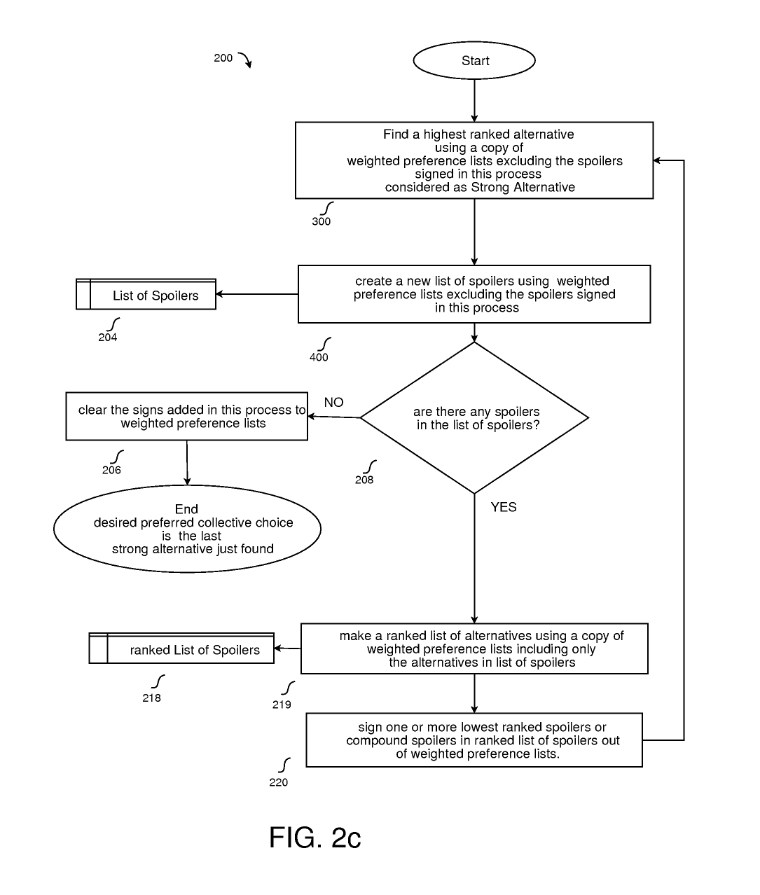

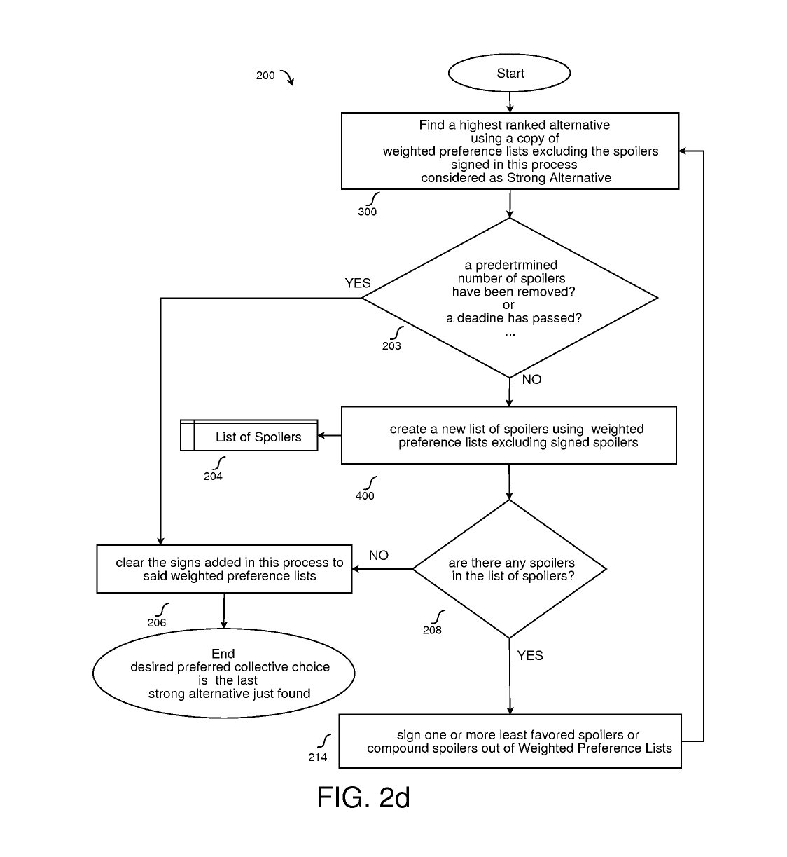

FIG. 2a is a flowchart showing the steps used in process 200 by some embodiments of this invention to find a preferred collective choice using given Weighted Preference Lists while restricting the impact of spoilers.

In step 300, a highest ranked alternative called Strong Alternative is found using said set of Weighted Preference Lists excluding signed spoilers. The Strong Alternative can be found by a variety of methods or collective choice procedures and will be used as a reference point in next steps. Signed spoilers are those alternatives that are detected in this process as spoilers in step 400 and are signed in step 214. At the first iteration of step 300, there is no signed spoiler.

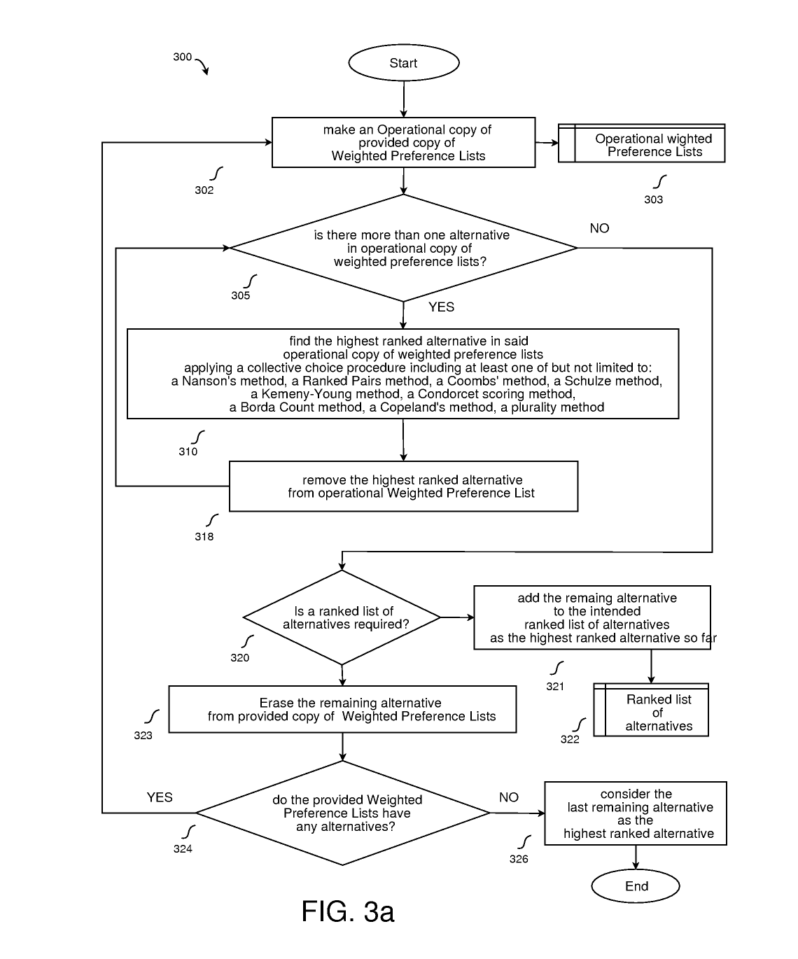

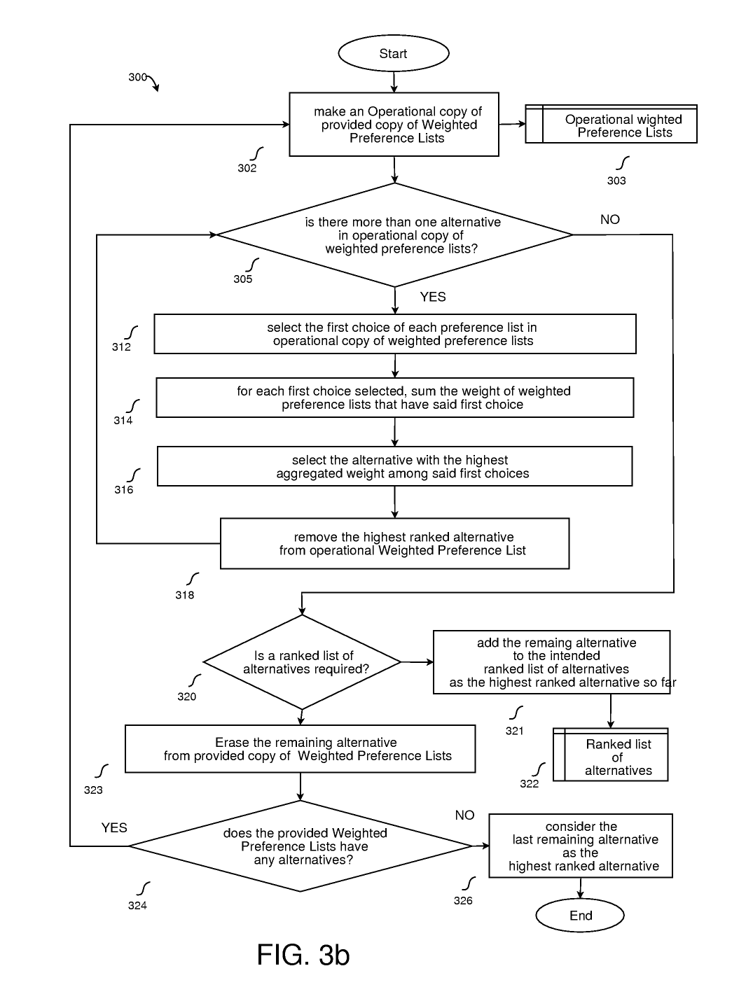

To find the highest ranked alternative, some embodiments of the invention generate a sequence of alternatives using given Weighted Preference Lists excluding signed spoilers by applying one or more preferential voting procedures selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method. Other embodiments apply a collective choice procedure repeatedly as shown in FIG. 3a or FIG. 3b using given Weighted Preference Lists excluding signed spoilers. In many examples described hereafter, where the repeated application of plurality in process 300 is used, collective choice procedures could be used as well.

In step 400, the Weighted Preference Lists excluding signed spoilers are analyzed and a List of Spoilers (list 204) is created. Some embodiments of this invention create an ordered List of Spoilers as part of process 400 and some just create a set of spoilers. Each spoiler can be simple (made of one alternative) or compound (made of a plurality of alternatives).

In Step 208, if no spoiler is detected, any signs added in the current process to the said Weighted Preference Lists are cleared in step 206, and this process is concluded while the last Strong Alternative found is considered as the desired preferred collective choice. If any spoiler has been detected and List of Spoilers is not empty, step 214 will follow.

In step 214, the spoilers in the List of Spoilers are analyzed, and the least favored among them is found and signed out of Weighted Preference Lists. In some embodiments, if alternatives in a compound spoiler are the least favored alternatives, all members of the compound are signed out. Some embodiments sign all the members of the compound spoiler if one of the members of a compound spoiler is the least preferred alternative. Some embodiments sign a plurality or all of spoilers in said List of Spoilers, out of said Weighted Preference Lists. Then steps 300, 400, 208 and the rest of steps are applied until no spoilers detected.

### Example 2

### An Embodiment in the Context of Deciding about the Production of a Drug

The preferences about production of Drugs A, B and C are collected and aggregated to a set of given Weighted Preference Lists as shown in list given WPL (Weighted Preference Lists) below:

### Given WPL:

### 40 B>C>A

### 32 C>A>B

### 28 A>B>C

Also let's assume that environmental circumstances dictate that only one of the drugs can be mass produced. When applying process 100 and using one of the embodiments of the process described in FIG. 2a. In step 200, among many possibilities, Borda count is used. In step 300, using Borda Count and sorting the candidates with the most points the result will be:

### Copy of Given WPL for Process 300:

### 40 B>C>A

### 32 C>A>B

### 28 A>B>C

### Points for A=40×0+32×1+28×2=88

### Points for B=40×2+32×0+28×1=108

### Points for C=40×1+32×2+28×0=104

Using Borda Count the highest ranked alternative called the Strong Alternative is found as shown below:

### Strong Alternative: (B)

In step 400, the Weighted Preference Lists are analyzed and it is found that the “Drug C” is the only spoiler because its removal changes the highest ranked alternative to (A) using the same, Borda Count, method. Therefore, C is added to the List of Spoilers.

### List of Spoilers: {C}

Step 208, finds a spoiler in List of Spoilers and in step 214, C is found the least favored spoiler and is signed out from Weighted Preference Lists which will result the weighted reference lists to be as shown below wherein signed alternative is in lowercase letters:

### Given WPL, C Signed:

40 B>c>A
32 c>A>B

### 28 A>B>c

In step 300, a Strong Alternative based on WPL excluding signed spoiler is found:

### A Copy of Given WPL, C Excluded for Process 300:

### 40 B>A

### 32 A>B

### 28 A>B

Using Borda Count and Sorting the Candidates with the Most Points, Results:

### Points for A=40×0+32×1+28×1=60

### Points for B=40×1+32×0+28×0=40

### Strong Alternative: (A)

In step 400, the Weighted Preference Lists excluding signed spoilers are analyzed but there can not be any spoilers between two alternatives. Therefore in step 208, the List of Spoilers will be found empty and in step 206, all the signs in Weighted Preference Lists are cleared. And the last Strong Alternative found is determined to be:

Preferred collective choice: (A)

In step 110, in process 100, therefore “Drug A” will be selected as the Independent Collective Choice. “Drug A” herein is called an Independent Collective Choice because the embodiments of this invention using Borda Count method would choose “Drug A” if “Drug C” was not introduced as an alternative and will choose “Drug A” if choice “Drug C” is introduced as an alternative.

### Example 3

### An Embodiment in the Context of Deciding about the Production of a Drug

The preferences about production of Drugs A, B and C are collected and aggregated to a set of given Weighted Preference Lists as shown in WPL (Weighted Preference Lists) below, also let's assume that environmental circumstances dictate that only one of the drugs can be mass produced and Ranked Pairs is the collective choice procedure used.

### Given WPL:

### 40 B>C>A

### 32 C>A>B

### 28 A>B>C

### Using Ranked Pairs and Sorting the Candidates the Process Will be:

AB=60, BA=40 therefore AB vector=20
BC=68, CB=32 therefore BC vector=32
AC=28, CA=72 therefore CA vector=44

Since A is preferred over B, and B over C, and C over A, there is a cycle and Ranked Pairs will remove the weakest vector which is AB and the result is that the collective preference will be (B>C>A) and “Drug B” will be the drug that will be produced.

However, when applying process 100 and using one of the embodiments of this invention described in FIG. 2a, in step 200, if Ranked Pairs is used, in step 300, a ranked list of alternatives called Strong Alternative is found as shown below:

### Strong Alternative: (B)

In step 400, the Weighted Preference Lists are analyzed and it is found that the “Drug C” is the only spoiler, because its removal changes the highest ranked alternative to (A) when using the same Ranked Pairs method. Therefore, C is added to the List of Spoilers. Notice that removing (A) doesn't change the highest ranked alternative. Therefore, the list of spoilers will be:

### List of Spoilers: {C}

In step 214, C is found to be the least favored spoiler and is signed out from Weighted Preference Lists which will result the weighted reference lists to be as shown in the following WPL wherein signed alternative is in lowercase letter:

### Given WPL, C Signed:

40 B>c>A
32 c>A>B

### 28 A>B>c

In step 300, a Strong Alternative based on WPL excluding signed alternative is found as shown in the following lists.

A copy of Given WPL, C Excluded for Process 300:

### 40 B>A

### 32 A>B

### 28 A>B

Using Ranked Pairs and Sorting the Candidates with the Most Points, Results:
AB=60, BA=40 and therefore, AB vector=20

This results in the following Strong Alternative:

### Strong Alternative: (A)

In step 400, the Weighted Preference Lists excluding signed spoilers are analyzed but there can not be any spoilers between two alternatives. Therefore in step 208, the List of Spoilers will be found empty and all the signs in Weighted Preference Lists are cleared and the last Strong Alternative found, is determined to be:

Preferred collective choice: (A)

In step 110, in process 100, therefore “Drug A” will be selected as the Independent Collective Choice.

“Drug A” is called an Independent Collective Choice because the embodiments of this invention using Ranked Pairs would choose “Drug A”, if choice “Drug C” was not introduced as an alternative, and will choose “Drug A”, if choice “Drug C” is introduced as an alternative.

FIG. 2b is a flowchart showing the steps used in process 200 in some embodiments of this invention to find a preferred collective choice using said Weighted Preference Lists while restricting the impact of spoilers. It recursively uses steps in process 100, when deciding which spoilers should be signed out, and will ensure that the existence of irrelevant alternatives among spoilers, when finding the least favored spoiler, will not influence the outcomes.

Steps 300, 400, 206 and 208 are identical to FIG. 2a described before.

In Step 208, if no spoiler is detected, step 206 will follow and any signs added in the current process to the Weighted Preference Lists are cleared and the process is concluded with the last found Strong Alternative considered as the desired preferred collective choice. If any spoiler is detected and List of Spoilers is not empty, step 216 will follow.

In step 216, to create a sorted list of spoilers, process 100 is recursively employed to produce an Independent Collective Choice Ordered List using a copy of said Weighted Preference Lists including only the alternatives in said List of Spoilers. If the number of spoilers detected in List of Spoilers is greater than two then some of them may act as spoilers for others. The outcome of step 216 is an Independent Collective Choice Ordered List of Spoilers and is shown as list 215.

In step 217, at least one of the lowest ranked spoilers in Independent Collective Choice Ordered List of Spoilers is signed out of Weighted Preference Lists. In some embodiments, if alternatives in a compound spoiler are the least favored alternatives, all members of the compound are signed out. Some embodiments sign all the members of the compound spoiler if one of the members of a compound spoiler is the lowest ranked alternative. Some embodiments sign a plurality or all of spoilers in said Independent Collective Choice Ordered List of Spoilers, out of said Weighted Preference Lists.

Then steps 300 and other steps in process 200 are repeated until no spoilers are detected.

### Example 4

### An Embodiment in the Context of Deciding about Investment on Technologies

Let's assume a number of technical advisors are sending their recommendations to the Chief Information Officer (CIO) of a company for a huge investment on computer technologies from 4 different vendors with different infrastructures. The advisors express their opinion the form of preference lists. Each technology has risks and advantages therefore there a no majority observed in preferences of technical advisors. The CIO must decide on which technology the investment must be done.

Let's assume that the CIO likes the Borda Count method as the collective choice procedure. The preferences about Technologies A, B, C and D are collected and aggregated to a set of given Weighted Preference Lists as shown in WPL (Weighted Preference Lists) below:

### Given WPL1:

### 42 B>D>C>A

### 10 C>D>A>B

### 18 A>B>D>C

### 30 A>C>D>B

The number in front of each preference list is the weight of that preference list, which in this case is the presentation of a combination of the number of technical advisors with that preference, and the confidence of CIO on those advisors. Using the Borda Count method, “Technology B” would be selected.

### Points for A=42×0+10×1+18×2+30*3=154

### Points for B=42×3+10×0+18×2+30*0=162

### Points for C=42×1+10×3+18×0+30*2=132

### Points for D=42×2+10×2+18×1+30*1=152

Borda Count Ranked list: (B>A>D>C)

Applying one of the embodiments of this invention based on process 100, step 200, will invoke process 200 in FIG. 2b. Step 300, using a copy of Weighted Preference Lists applying Borda Count, finds a Strong Alternative. According to calculations above, is created as shown below:

### Strong Alternative: (B)

In step 400, the Weighted Preference Lists are analyzed without “Technology C”:

WPL without C:

### 42 B>D>A

### 10 D>A>B

### 18 A>B>D

### 30 A>D>B

### Points for A=42×0+10×1+18×2+30×2=106

### Points for B=42×2+10×0+18×1+30×0=102

### Points for D=42×1+10×2+18×0+30×1=92

### Borda Count Highest Ranked Alternative: (A)

This has a different highest ranking alternative than the Strong Alternative and leads to considering “Technology C” a spoiler.

The same preference Lists without “Technology D” will result:

WPL without D:

### 42 B>C>A

### 10 C>A>B

### 18 A>B>C

### 30 A>C>B

### Points for A=42×0+10×1+18×2+30×2=106

### Points for B=42×2+10×0+18×1+30×0=102

### Points for D=42×1+10×2+18×0+30×1=92

Borda Count highest ranked alternative: (A)
This has a different highest ranking alternative than the Strong Alternative (B) and leads to considering “Technology D” a spoiler. It is found that “Technology C” and “Technology D” are both spoilers because they are not selected technologies but their removal changes the selected choice using the same Borda Count method. Therefore, C and D are added to the List of Spoilers.

### List of Spoilers: {C,D}

In step 216, to create a sorted list of spoilers, process 100 is recursively applied using a copy of Weighted Preference Lists including only the spoilers.

### Copy of WPL Including Only the Spoilers:

### 42 D>C

### 10 C>D

### 18 D>C

### 30 C>D

Process 100 using Borda count produces an Independent Collective Choice Ordered List as shown below:

### Independent Collective Choice Ordered List of Spoilers=(D>C)

C is the lowest ranked alternative in Independent Collective Choice Ordered List of Spoilers, and is considered as the least favored spoiler and is signed out from Weighted Preference Lists which will result the Weighted Preference Lists to be as shown below wherein signed alternatives are in lowercase letters:

### WPL Spoilers Signed:

42 B>D>c>A
10 c>D>A>B

### 18 A>B>D>c

30 A>c>D>B

Step 300, using a copy of Weighted Preference Lists without C, applying Borda Count finds a Strong Alternative as shown below:

Copy of WPL without C:

### 42 B>D>A

### 10 D>A>B

### 18 A>B>D

### 30 A>D>B

### Strong Alternative: (A)

In step 400, the Weighted Preference Lists excluding signed spoilers are analyzed and no spoilers are found. Therefore in step 208, the List of Spoilers will be found empty and in step 206, all the signs in Weighted Preference Lists are cleared and the last Strong Alternative found is determined to be:

Highest ranked alternative: A

In step 110, in process 100, “Technology A” will be selected as the Independent Collective Choice.

FIG. 2c is a flowchart showing the steps used in process 200 in some embodiments of this invention to find a preferred collective choice using given Weighted Preference Lists while restricting the impact of spoilers by making a ranked list of spoilers when deciding which spoilers should be signed out. It can use a collective choice procedure that creates a ranked list of spoilers like Borda Count or can use process 300, as explained in FIG. 3a and FIG. 3b.

Steps 300, 400, 206 and 208 are identical to FIG. 2a described before.

In Step 208, if no spoiler is detected, step 206 will follow and any signs added in the current process to the Weighted Preference Lists are cleared and the process is concluded and the Strong Alternative last selected is the desired preferred collective choice outcome. If any spoiler is detected and List of Spoilers is not empty, step 219 will follow.

In step 219, a sorted list of spoilers, a ranked list of alternatives is made. Some embodiments of the invention generate a sequence of alternatives using given Weighted Preference Lists including only alternatives in the list of spoilers by applying one or more preferential voting methods selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method. Other embodiments apply a collective choice procedure repeatedly to make a ranked list of alternatives by applying process 300 shown in FIG. 3a or FIG. 3b using given Weighted Preference Lists including only alternatives in the list of spoilers. The result of step 219 is a ranked List of Spoilers shown as list 218.

In step 220, at least one of the lowest ranked spoilers in Independent Collective Choice Ordered List of Spoilers is signed out of Weighted Preference Lists. In some embodiments, if alternatives in a compound spoiler are the least favored alternatives, all members of the compound are signed out. Some embodiments sign all the members of the compound spoiler if one of the members of a compound spoiler is the lowest ranked alternative. Some embodiments sign a plurality or all of spoilers in said Independent Collective Choice Ordered List of Spoilers, out of said Weighted Preference Lists.

Then steps 300 and other steps in process 200 are repeated until no spoilers are detected.

FIG. 2d is a flowchart showing the steps used in process 200 by some embodiments of this invention to find a preferred collective choice using given Weighted Preference Lists while restricting the impact of spoilers with early termination option. This way a decision can be made after some spoilers are signed and before all the spoilers are signed and excluded to make faster decisions.

In step 300, a Strong Alternative is found using said set of Weighted Preference Lists excluding signed spoilers similar to what was explained for FIG. 2a.

In step 203, if a predetermined number of spoilers have been removed, a dead line has passed or based on some other criteria, the search for more spoilers stops and in step 206, signs will be cleared; otherwise search for spoilers will continue in step 400.

Steps 400, 208, 300 and 206 are performed the same as process explained in FIG. 2a.

FIG. 3a is a flowchart showing the steps used in process 300 by some embodiments of this invention for finding the highest ranked alternative as well as making a ranked list of alternatives using provided copy of Weighted Preference Lists by applying a collective choice procedure repeatedly. One of the advantages of this method over prior art is that it can create a ranked list of alternatives. Another one of many advantages is that it doesn't simply use a preferential voting system to select one or more weak alternatives to eliminate. It creates a ranked list by applying a collective choice procedure removing highest ranked alternatives repeatedly before deciding which alternative is the lowest ranked alternative, then records and erases the lowest ranked alternative found in this way from said lists and repeats this process until it finds the highest ranked at the end. This process can use “collective choice procedures that declare a single winner” repeatedly to create a ranked List of Spoilers.

In step 302, an operational copy of the provided copy Weighted Preference Lists is made which is shown as list 303.

In step 305, it is verified that there are more than one alternative in the operational copy of Weighted Preference Lists. If there is only one alternative remaining, that alternative will be considered the highest ranked alternative.

If in step 305 more than one alternative are found in the operational copy of Weighted Preference Lists, then in step 310, a collective choice procedure is applied to find the best choice in said operational copy of Weighted Preference Lists. The collective choice procedure can be selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method.

In step 318, the chosen alternative is removed from operational copy of Weighted Preference Lists and then steps 305, 310 and 318 are repeated until only one alternative remains in the operational copy of Weighted Preference Lists.

In step 305, if there is only one alternative remaining, step 320 will follow. In step 320, it is checked if a ranked list is required and step 321 will add the remaining alternative at the top of ranked list of alternatives which is shown as list 322 and in step 323, it is erased from the provided copy of Weighted Preference Lists.

In step 324, it is decided whether to continue with 302. If there is no more alternatives in provided copy of Weighted Preference Lists, step 326 will be performed. If there are more than one alternative in provided copy of Weighted Preference Lists then the steps 302 to 324 are repeated with fewer and fewer number of alternatives in provided copy of Weighted Preference List.

In each round another alternative is selected to be added to the top of ranked list of alternatives. Some embodiments of process 300 that are searching for a collective choice set, can consider all the remaining alternatives in provided copy of Weighted Preference Lists as collective choice set when there is a predetermined number of alternatives remaining.

In step 326, the last remaining alternative is considered as the highest ranked alternative and the process is concluded. At the end of process 300 the operational and provided copy of Weighted Preference List are not needed any more.

Some embodiments of process 300 can use temporarily excluding techniques instead removing and erasing using a copy of the Weighted Preference Lists.

FIG. 3b is a flowchart showing the steps used in process 300 by some embodiments of this invention to find the highest ranked alternative as well as to make a ranked list of alternatives from a provided copy of Weighted Preference Lists by applying plurality collective choice procedure repeatedly.

In step 302, an operational copy of the provided copy of Weighted Preference Lists is made which is shown as list 303.

In step 305, it is verified that there are more than one alternative in the operational copy of Weighted Preference Lists. If there is only one alternative remaining, that alternative will be considered the highest ranked alternative.

If in step 305 more than one alternative are found in the operational copy of Weighted Preference Lists, then in step 312, the first choice of each preference list in said operational copy of Weighted Preference Lists is selected. In step 314, for each first choice selected, sum of the weight of said Weighted Preference Lists that have said first choice is calculated. In step 316, the alternative with the highest aggregated weight among said first choices is selected as the highest ranked alternative.

In step 318, the chosen alternative is removed from operational copy of Weighted Preference Lists and then steps 305 to 318 are repeated until only one alternative remains in the operational copy of Weighted Preference Lists.

In step 305, if there is only one alternative remaining, step 320 will follow. In step 320, it is checked if a ranked list is required and step 321 will add the remaining alternative at the top of ranked list of alternatives which is shown as list 322 and in step 323, it is erased from the provided copy of Weighted Preference Lists.

Some embodiments of process 300 can use temporarily excluding techniques instead removing and erasing using a copy of the Weighted Preference Lists.

In step 324, it is decided whether to continue with 302. If there is no more alternatives in provided copy of Weighted Preference Lists, step 326 will be performed. If there are more than one alternative in provided copy of Weighted Preference Lists then the steps 302 to 324 are repeated with fewer and fewer number of alternatives in provided copy of Weighted Preference List.

In each round another alternative is selected to be added to the top of ranked list of alternatives. Some embodiments of process 300 that are searching for a collective choice set, consider all the remaining alternatives in provided copy of Weighted Preference Lists as collective choice set when there is a predetermined number of alternatives remaining.

In step 326, the last remaining alternative is considered as the highest ranked alternative and the process is concluded. At the end of process 300 the operational and provided copy of Weighted Preference List are not needed any more.

Some embodiments of process 300 can use temporarily excluding techniques instead removing and erasing using a copy of the Weighted Preference Lists.

### Example 5

### An Embodiment of this Invention Used in a State Wide Election to Find the Highest Ranked Alternative

In this example, it will be shown how some embodiments of this invention use process 300 as explained in FIG. 3b to find a Highest Ranked Alternative.

Let's assume, in the presidential elections in one state with three candidates; Albert, George and Ralph the preferences of voters are as shown in the following lists:

### Given WPL:

### 2911872 George, Albert, Ralph

### 2010002 Albert, George, Ralph

### 900940 Albert, Ralph, George

### 97419 Ralph, Albert, George

In process 100, step 200 will be performed. In step 300 of process 200, some embodiments use flowchart in FIG. 3b that uses a plurality method repeatedly. In this case, in step 302 in FIG. 3b, an operational copy of Weighted Preference Lists is created as:

### Operational Copy of WPL:

### 2911872 George, Albert, Ralph

### 2010002 Albert, George, Ralph

### 900940 Albert, Ralph, George

### 97419 Ralph, Albert, George

In step 305, the Operational copy Weighted Preference Lists are found with more than one alternative.

In step 310 to 318, George is removed from said Operational copy Weighted Preference Lists because he has the most aggregated weight. In step 305, the Operational copy Weighted Preference Lists are found with more than one alternative. In step 310 to 318, Albert is removed Operational copy Weighted Preference Lists because he has the most aggregated weight. In step 305, the Operational copy Weighted Preference Lists are found with one alternative. And in step 320 it is decided that step 321 can be skipped since step 200 of process 300 doesn't need a ranked list. In step 323, Ralph is erased from the provided Weighted Preference Lists:

### Provided Copy of Replica WPL:

### 2911872 George, Albert

### 2010002 Albert, George

### 900940 Albert George

### 97419 Albert, George

In step 305, the Operational copy Weighted Preference Lists are found with more than one alternative. In step 310 to 318, Albert is removed from Operational copy Weighted Preference Lists, because he has the most aggregated weight. In step 305, the Operational copy Weighted Preference Lists are found with one alternative. In step 320, it is decided that step 321 can be skipped since step 200 of process 300 doesn't need a ranked list. In step 323, George is erased from the provided Weighted Preference Lists:

In step 305, the Operational copy Weighted Preference Lists are found with one alternative. In step 320, it is decided that step 321 can be skipped since step 200 of process 300 doesn't need a ranked list. In step 323, Albert is erased from the provided Weighted Preference Lists and in step 326 is considered as the Highest Ranked Alternative

In step 400, no spoilers will be found and in step 208, process 200 is concluded and Albert as the highest ranked alternative will be considered the Independent Collective Choice in step 110 and step 130 will decide to end the process 100.

### Example 6

### Embodiment of Process 300 in FIG. 3b to Create a Ranked List of Alternatives

In this example, it will be shown how some embodiments of this invention use process 300 as explained in FIG. 3b to make a ranked list of alternatives as part of step 300 in process 200, using plurality method.

The preferences about three alternatives are shown in the following provided copy Weighted Preference Lists:

### Provided Copy of WPL:

### 3020 Bob>Alan>Carol

### 1014 Bob>Carol>Alan

### 3023 Carol>Alan>Bob

### 2522 Alan>Bob>Carol

The number in front of each preference list is the number of voters who have that preference list. If the election system is plurality only the first choice of the voters matter and Bob will be elected with relative majority. If the voting system is Runoff Voting or Instant Runoff Voting, the candidate with lowest first votes (Alan) will be taken out and the first votes after that will be considered.

### WPL in Second Round of IRV Alan Taken Out:

### 4034 Bob>Carol

### 3023 Carol>Bob

### 2522 Bob>Carol

This will result in the election of Bob in second round of IRV.

The embodiments of process 300 according to FIG. 3b will make the ranked list of these candidates in a different order. In step 302, an operational copy of the provided copy of Weighted Preference Lists is created:

### Operational Copy of WPL:

### 3020 Bob>Alan>Carol

### 1014 Bob>Carol>Alan

### 3023 Carol>Alan>Bob

### 2522 Alan>Bob>Carol

In step 305, it is confirmed that more than one alternative is in the Weighted Preference Lists.

In step 312, the first choice of each preference list in the operational copy of Weighted Preference Lists is selected which are Bob, Carol and Alan.

In step 314, for each first choice selected, the weight of Weighted Preference Lists that have said first choice is summed together.

Top Choices with Aggregated Weight:

### 4034 Bob

### 3023 Carol

### 2522 Alan

In step 316, the alternative with the highest aggregated weight among said first choices (Bob) is selected. In step 318, Bob is removed from operational copy of Weighted Preference Lists.

The operational copy of Weighted Preference Lists after this step is shown below:

### Operational Copy of WPL Bob Removed:

### 3020 Alan>Carol

### 1014 Carol>Alan

### 3023 Carol>Alan

### 2522 Alan>Carol

In step 305, it is verified that the operational copy Weighted Preference Lists have more than one alternative and steps 312, 314 and 316 will result in selection of Alan as the highest ranked alternative which is removed from operational copy of Weighted Preference Lists in step 318.

The operational copy of Weighted Preference Lists after this step is shown below:

### Operational Copy of WPL Alan Removed:

### 3020 Carol

### 1014 Carol

### 3023 Carol

### 2522 Carol

In step 305, only one alternative is found in the Operational copy of Weighted Preference Lists. In step 320 it is noticed that a ranked list of alternatives is required and, in step 321, that alternative, Carol, is added to ranked list of alternatives, as the highest ranked alternative so far.

Ranked list of alternatives: (Carol)

In step 323, Carol is erased from provided copy of Weighted Preference Lists which results in:

### Provided Copy of WPL Carol Erased:

### 3020 Bob>Alan

### 1014 Bob>Alan

### 3023 Alan>Bob

### 2522 Alan>Bob

In step 324, this list is found not empty and step 302 is repeated which creates an operational copy of Weighted Preference Lists:

### Operational Copy of WPL:

### 3020 Bob>Alan

### 1014 Bob>Alan

### 3023 Alan>Bob

### 2522 Alan>Bob

In step 305, it is verified that the Weighted Preference Lists have more than one alternative and step 312, 314 and 316 will result in selection of Alan as the highest ranked alternative which is removed from operational copy of Weighted Preference Lists in step 318.

### Operational Copy of WPL:

### 3020 Bob

### 1014 Bob

### 3023 Bob

### 2522 Bob

In step 305, only one alternative is found in the Weighted Preference Lists and that alternative. Step 320 will decide that step 321 should add Bob to ranked list of alternatives as the highest ranked alternative so far.

Ranked list of alternatives: (Bob>Carol)

In step 323, Bob is erased from provided copy of Weighted Preference Lists which results in:

Provided copy of WPL Bob Erased:

### 3020 Alan

### 1014 Alan

### 3023 Alan

### 2522 Alan

And because this list is not empty, step 302 is repeated which creates an operational copy of Weighted Preference Lists:

### Operational Copy of WPL:

### 3020 Alan

### 1014 Alan

### 3023 Alan

### 2522 Alan

Step 305 finds one alternative in operational Weighted Preference Lists and after step 320 and step 321 adds it to Ranked list of alternatives as the highest ranked alternative so far:

Ranked list of alternatives: (Alan>Bob>Carol)

In step 323 Alan, is erased from provided copy of Weighted Preference Lists and step 324 will find it empty which will lead to process 326 where Alan is considered as the highest ranked alternative and process 300 ends with Ranked list of alternatives containing the intended list.

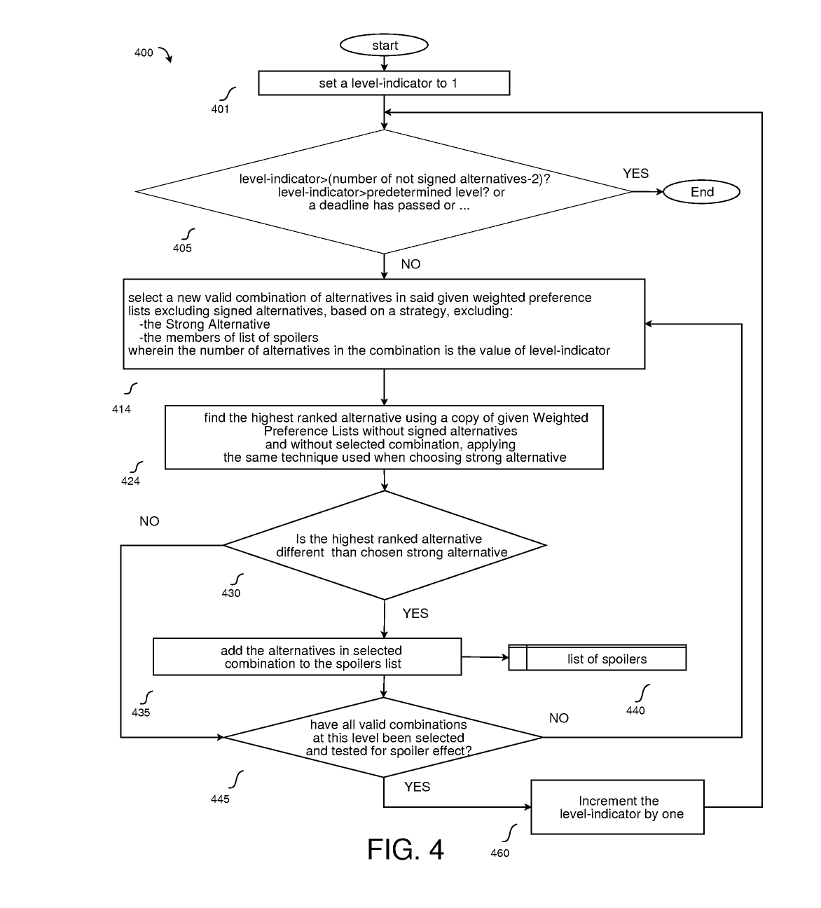

FIG. 4 is a flowchart showing the steps used in process 400 by some embodiments of this invention to create a new List of Spoilers using a given set of Weighted Preference Lists and a provided Strong Alternative. Whenever ranking is needed in process 400, it uses the same ranking method used in search for Strong Alternative. Some of the embodiments of this invention use this process repeatedly in process 200 and therefore some of the alternatives in Weighted Preference Lists may have been signed out, before this process receives the given Weighted Preference Lists.

In step 401, a level-indicator is set to level 1. The level-indicator is a counter that starts at one, meaning that at first the alternatives will be tested one by one to check the effect of their removal on highest ranked alternative. And then in the next step it will change to two, which means in that iteration the alternatives will be tested two by two to check the effect of their removal on highest ranked alternative.

In step 405, the level-indicator is compared with the number of alternatives in given Weighted Preference Lists that are not signed. If the level-indicator is more than “the number of alternatives in given Weighted Preference Lists excluding signed alternatives minus 2”, the process is concluded.

For example, if the number of alternatives is 2, this process will conclude at the beginning since 2−2 is 0 and the level-indicator is 1 that is greater than 0. This is desired because there can't be any spoilers between two alternatives. If the number of alternatives is more than 2, this process will not conclude at the beginning. For example, if the number of valid alternatives is 3, since 3−2 is 1 and the level-indicator is 1 that is not greater than 1, the process will continue to step 414.

Some embodiments of this invention can also conclude this process in step 405 if at least one of, but not limited to, the following happens: the level-indicator is more than a predetermined level, a deadline has reached or a predetermined number of spoilers are found.

In step 414, a new valid combination of alternatives, in said given Weighted Preference Lists excluding signed alternatives, is selected based on a strategy. This combination is a set of alternatives wherein the number of alternatives in the set is the level-indicator. The selected combination does not include Strong Alternative, or simple or compound spoilers in the List of Spoilers.

For example, if said Strong Alternative is A, and the alternatives in Weighted Preference Lists excluding signed alternatives are {A,B,C}, the valid combinations with level-indicator equal to 1 will be the combinations of alternatives from set of {B,C}, which are B or C. If the alternatives in Weighted Preference Lists excluding signed alternatives are {A,B,C,D}, the valid combination with level-indicator equal to 1 will be three combinations of alternatives from set of {B,C,D} which are B or C or D and with level-indicator equal to 2, there can be three valid combinations of alternatives from set of {B,C,D} which are BC, BD or CD.

Notice that a spoiler in the List of Spoilers can be an alternative or a combination of alternatives. In some embodiments, when selecting new combinations, the members of a compound spoiler are tested in combination with other alternatives but the compound itself isn't tested in combination with others. For example, if there are 6 alternatives {A,B,C,D,E,F}, and (A) is found as Strong Alternative and List of Spoilers is {D, BC} which have already been detected in process 400, then when the level-indicator is 3, the combination (DBC) is not selected to be tested because D is already a spoiler and the combination (BCE) is not selected to be tested because the compound spoiler BC is already known as a spoiler. However, the combination (BEF) is a valid combination for being selected to be tested.

Some embodiments choose some optimization strategies to maximize the speed of decision making by selecting the combinations from a certain subset of alternatives, or by selecting the alternatives with certain order or according to some algorithms.

In step 424, the highest ranked alternative is found using a copy of said supplied Weighted Preference Lists without the alternatives in selected combination. The method used for creating this ranked list must be identical to what has been used for finding the Strong Alternative.

In step 430, the highest ranked alternative and Strong Alternative are compared to see if they are different. If they are found different, in step 435, the combination that was selected is considered to be a spoiler and is added to the anticipated List of Spoilers (list 440).

In step 445, it is verified if all the valid combinations at the current value of level-indicator have been selected and tested for spoiler effect. The valid combination is a set of alternatives wherein the number of alternatives in the combination is the level-indicator and the selected combination does not have the alternatives that are signed, the Strong Alternative or the members of List of Spoilers. If all of the valid combinations at this level-indicator are not tested yet, step 414 and its next steps are repeated.

If all of the valid combinations at this level-indicator are tested, in step 460, the level-indicator is incremented by one and step the 405 and its next steps are repeated.

### Example 7

### An Embodiment of this Invention Used in a National Election

In this example, it will be shown how some embodiments of this invention use process 400 as explained in FIG. 4 to find the spoilers in a given set of Weighted Preference Lists in step 400 in process 200 FIG. 2a.

Let's assume, in a hypothetical presidential election with three candidates; Bill, George and Ross the preferences of voters are as shown in the following lists:

### Given WPL:

### 44,909,806 Bill, Ross, George

### 29,004,050 George, Ross, Bill

### 10,100,500 George, Bill, Ross

### 19,743,821 Ross, George, Bill

If plurality is used Bill will be elected.

In some embodiments of this invention, in process 100, step 200 will be performed. In process 200, in step 300, some embodiments use flowchart in FIG. 3b that uses plurality repeatedly to find the highest ranked alternative:

After creation of an operational copy in step 302, and decision in step 305, in steps 312 to 318 Bill is selected and removed and then Ross is selected and removed from operational copy. In Step 320, a ranked list is not required. In step 323, George is erased from provided Weighted Preference Lists.

### Provided Copy WPL in Process 300 George Erased:

### 44,909,806 Bill, Ross

### 29,004,050 Ross, Bill

### 10,100,500 Bill, Ross 19,743,821 Ross, Bill

Repeating the steps with remaining Bill and Ross the highest ranked alternative selected in FIG. 3b is the following:

Highest ranked Alternative: (Bill)
Which means in step 300 of process 300 the Strong Alternative is determined:

### Strong Alternative=(Bill)

In step 400 of process 200, some embodiments of this invention use process 400 as explained in FIG. 4 to create a List of Spoilers.

In step 401, the level-indicator is set to 1. In step 405, it is found that the number of alternatives minus 2 is more than, the level-indicator. In step 414, from the one member combinations of the three candidates only Ross or George are valid because the Strong Alternative is not considered a valid spoiler. For the first iteration Ross is selected.

In step 424, performing the same method explained in FIG. 3b, using a copy of given Weighted Preference Lists without signed alternatives and selected combination, the highest ranked alternative is found.

Copy of Given WPL without Ross Used by in Process 300:

### 44,909,806 Bill, George

### 29,004,050 George, Bill

### 10,100,500 George, Bill

### 19,743,821 George, Bill

Highest ranked alternative=(George)

In step 430, Highest ranked alternative (George) and Strong Alternative: (Bill) are compared and it is found that the result is not the same. Therefore, Ross is added to the List of Spoilers.

### List of Spoilers={Ross}

In step 445, it is found that a valid combination in this level that is George is not tested for spoiler effect yet. In step 414, George is selected and in step 424, performing the same method explained in FIG. 3b, using a copy of given Weighted Preference Lists without George, the highest ranked alternative is found.

Copy of Given WPL without George Used by Process 300:

### 44,909,806 Bill, Ross

### 29,004,050 Ross, Bill

### 10,100,500 Bill, Ross

### 19,743,821 Ross, Bill

Highest ranked alternative=(Bill)

In step 430, the highest ranked alternative (Bill) and Strong Alternative: (Bill) are compared and it is found that they are consistent.

In step 445, it is verified that all valid combinations are checked and in step 460, level-indicator is incremented to 2.

In step 405, it is found that level-indicator (2) is not greater than “number of not signed alternatives minus two” (4−2), therefore the process 400 is concluded.

Back to FIG. 2a, in step 208, it is realized that a spoiler is in List of Spoilers, and in step 214, Ross who is in List of Spoilers is signed in Weighted Preference Lists.

### Given WPL Ross Signed:

44,909,806 Bill, ross, George
29,004,050 George, ross, Bill
10,100,500 George, Bill, ross
19,743,821 ross, George, Bill
Signed alternative is shown starting with lower case letter.

Step 300, finds the highest ranked alternative using Weighted Preference Lists excluding Ross and will lead to:

### Provided Copy of WPL Excluding Ross Used by Process 300:

### 44,909,806 Bill, George

### 29,004,050 George, Bill

### 10,100,500 George, Bill

### 19,743,821 George, Bill

Highest ranked Alternative: (George)
Which means in step 300 of process 300 the Strong Alternative is determined:

### Strong Alternative=(George)

Step 400 finds no spoiler between two alternatives and step 208 decides that the next step is 206.

In step 206, all the signs added in this process are removed.

And the highest ranking alternative George will be selected as desired preferred collective choice. In step 110 in FIG. 1, George is selected as the Independent Collective Choice.

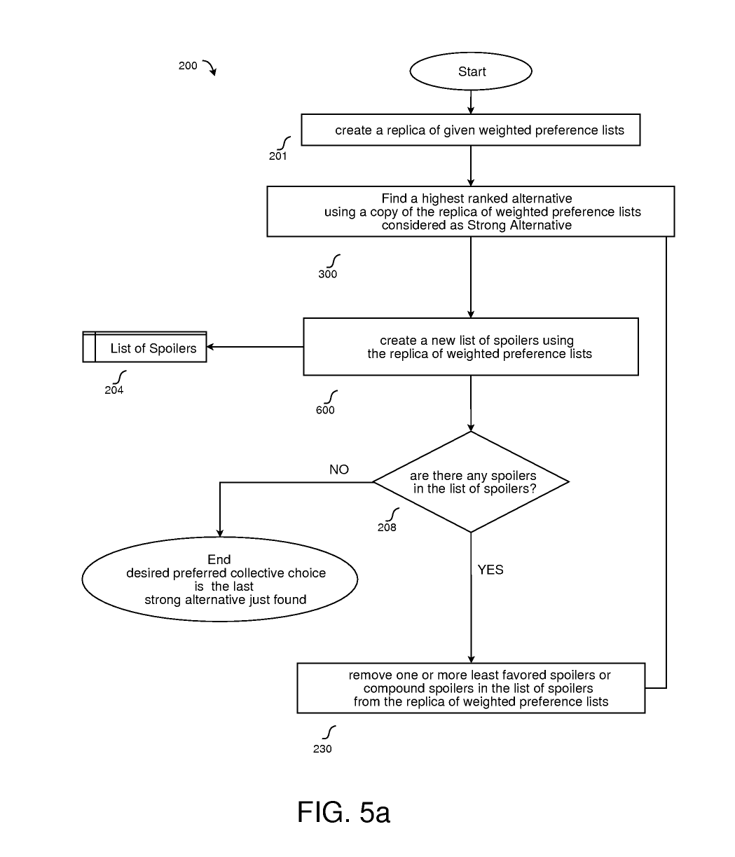

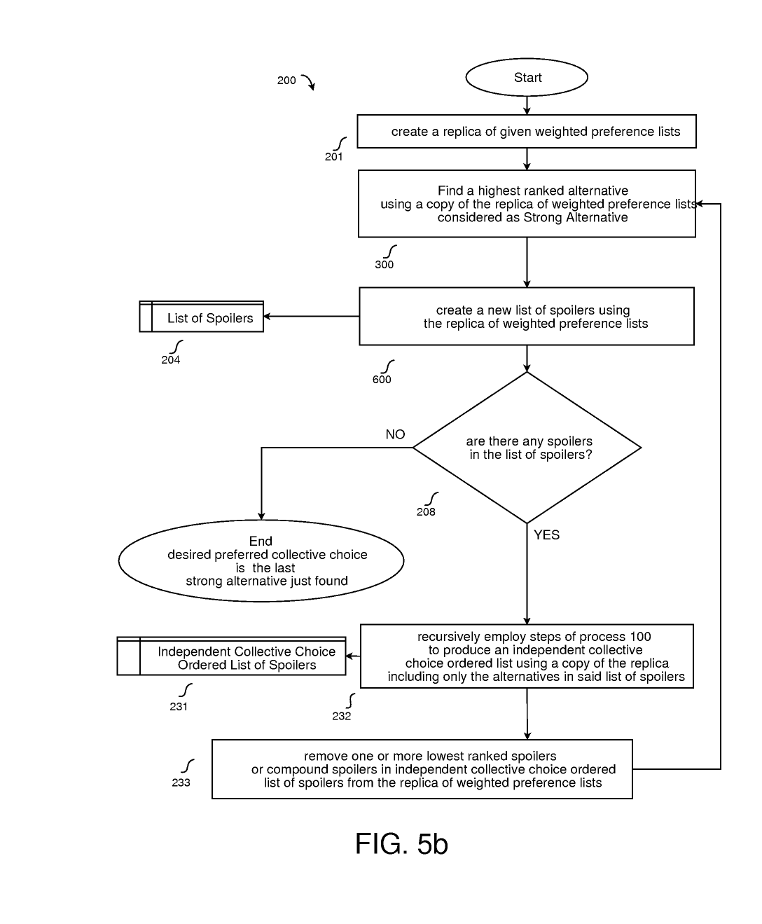

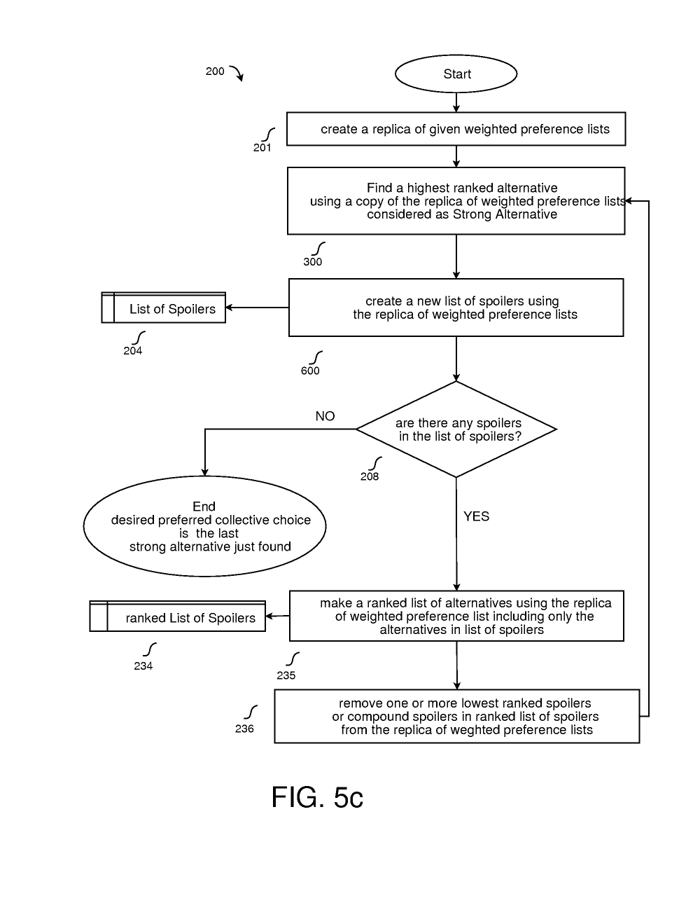

FIG. 5a is a flowchart showing the steps used in process 200 by some embodiments of this invention to find a preferred collective choice using given Weighted Preference Lists while restricting the impact of spoilers. This embodiment uses a replica of Weighted Preference Lists and removes detected spoilers from the replica instead of signing the spoilers in the given Weighted Preference Lists.

In step 201, a replica of the given Weighted Preference Lists is created.

In step 300, a Strong Alternative is found using the given set of Weighted Preference Lists by one of many possible vote aggregation methods.

To find a Strong Alternative, some embodiments of the invention apply one or more preferential voting methods selected from the group consisting of but not limited to: a Ranked Pairs method, an Instant-Runoff Voting, a Schulze method, a Kemeny-Young method, a Condorcet scoring method, a Borda Count method. Other embodiments apply a collective choice procedure repeatedly to find a preferred collective choice as shown in FIG. 3a or FIG. 3b using a copy of said provided Weighted Preference Lists.

In step 600, the Weighted Preference Lists are analyzed and a List of Spoilers (list 204) is created. Some embodiments of this invention create an ordered List of Spoilers as part of process 600 and some just create a set of spoilers. The spoilers can be simple (made of one alternative) or compound (made of a plurality of alternatives).

In Step 208, if no spoiler is detected, the replica is not needed anymore and the process is concluded. If any spoiler is detected and List of Spoilers is not empty, in step 230, the spoiler combinations in the List of Spoilers are analyzed and the least favored among them is found and removed from the replica of Weighted Preference Lists. In some embodiments, if alternatives in a compound spoiler are the least favored alternatives, all members of the compound are removed. Some embodiments remove all the members of the compound spoiler if one of the members of a compound spoiler is the least preferred alternative. Some embodiments remove a plurality or all of spoilers in said sorted List of Spoilers, out of said replica of Weighted Preference Lists.

Then steps 300, 600 and the rest of steps in process 200 in FIG. 5a are applied to Weighted Preference Lists.

FIG. 5b is a flowchart showing the steps used in process 200 by some embodiments of this invention to find a preferred collective choice using given Weighted Preference Lists while restricting the impact of spoilers by recursively using steps in process 100 when deciding which spoilers should be removed. This embodiment uses a replica of Weighted Preference Lists and removes detected spoilers from the replica. This embodiment also uses the process 100 recursively which will ensure that the existence of irrelevant alternatives among spoilers when finding the least favored spoiler will not influence the outcomes.

Steps 201, 300, 600, and 208 are identical to FIG. 5a described before.

If any spoiler is detected and List of Spoilers is not empty, in step 232, process 100 is recursively employed to produce an Independent Collective Choice Ordered List using a copy of said replica of Weighted Preference Lists including only the alternatives in said List of Spoilers. If the number of spoilers detected in List of Spoilers is greater than two then some of them may act as spoilers for others. The outcome of step 232 is shown as list 231.

In step 233, at least one of the lowest ranked spoilers in Independent Collective Choice Ordered List of Spoilers is removed from Weighted Preference Lists. In some embodiments, if alternatives in a compound spoiler are the least favored alternatives, all members of the compound are signed out. Some embodiments sign all the members of the compound spoiler if one of the members of a compound spoiler is the lowest ranked alternative. Some embodiments sign a plurality or all of spoilers in said Independent Collective Choice Ordered List of Spoilers, out of said Weighted Preference Lists.

Then steps 300 and other steps in process 200 are repeated until no spoilers are detected.

FIG. 5c is a flowchart showing the steps used in process 200 by some embodiments of this invention to find a preferred collective choice using given Weighted Preference Lists while restricting the impact of spoilers by making a ranked List of Spoilers when deciding which spoilers should be removed. This embodiment uses a replica of Weighted Preference Lists and removes detected spoilers from the replica. It uses a collective choice procedure that creates a ranked list of spoilers like Borda Count, or uses process 300, as explained in FIG. 3a and FIG. 3b.

Steps 201, 300, 600, and 208 are identical to FIG. 5a described before.

If any spoiler is detected and List of Spoilers is not empty, in step 235, a ranked list of alternatives is made, some embodiments of the invention generate a sequence of alternatives using said replica of Weighted Preference Lists including only alternatives in the list of spoilers by applying one or more preferential voting methods selected from the group consisting of but not limited to: a Ranked Pairs method, an Instant-Runoff Voting, a Schulze method, a Kemeny-Young method, a Condorcet scoring method, a Borda Count method. Other embodiments apply a collective choice procedure repeatedly to make a ranked list of alternatives by applying process 300 shown in FIG. 3a or FIG. 3b using given Weighted Preference Lists including only alternatives in the list of spoilers. The result of step 235 is a ranked List of Spoilers shown as list 234.

In step 236, at least one of the lowest ranked spoilers in Independent Collective Choice Ordered List of Spoilers is removed from Weighted Preference Lists. In some embodiments, if alternatives in a compound spoiler are the least favored alternatives, all members of the compound are signed out. Some embodiments sign all the members of the compound spoiler if one of the members of a compound spoiler is the lowest ranked alternative. Some embodiments sign a plurality or all of spoilers in said Independent Collective Choice Ordered List of Spoilers, out of said Weighted Preference Lists.

Then steps 300 and other steps in process 200 are repeated until no spoilers are detected.

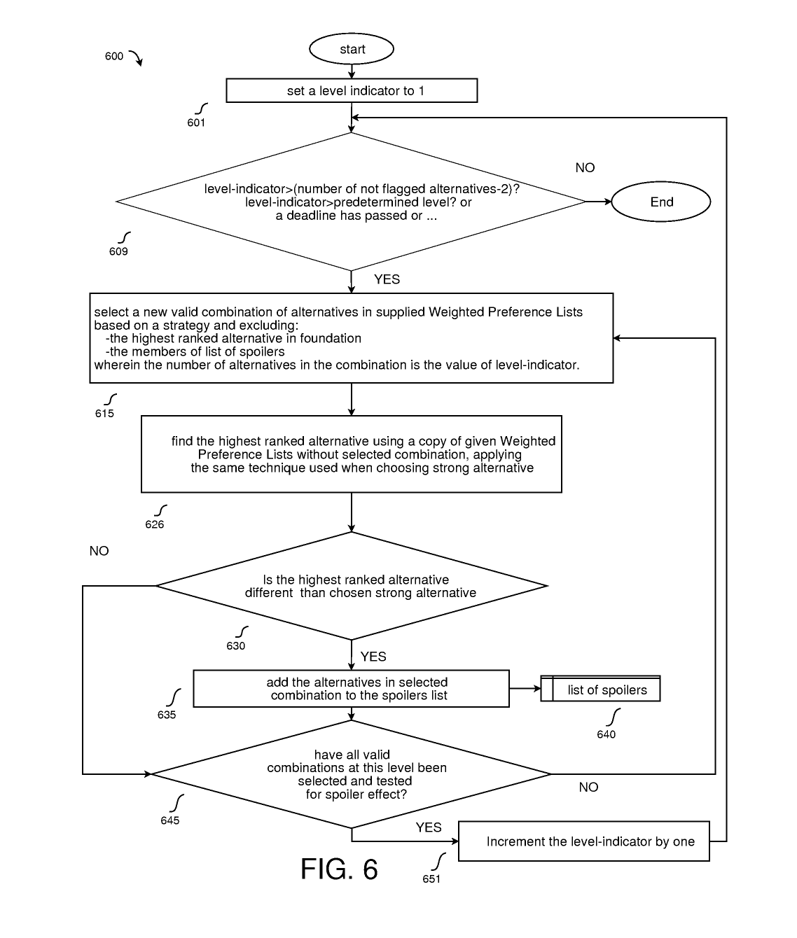

FIG. 6 is a flowchart showing the steps used in process 600 by some embodiments of this invention to create a new List of Spoilers using a supplied set of Weighted Preference Lists and a Strong Alternative. Whenever ranking is needed in process 600, it uses the same ranking method used for the creation of Strong Alternative.

This process is identical to process in FIG. 4, except that it assumes: any alternative that should not be considered in the current search for spoilers has already been removed from the supplied Weighted Preference Lists.

In step 601, a level-indicator is set to level 1. The level-indicator is a counter that starts at 1 meaning that the alternatives are tested one by one to check the effect of their removal on the highest ranked alternative found. And then in next round it changes to 2, which means, in that iteration the alternatives will be tested two by two to check the effect of their removal.

In step 609, the level-indicator is compared with the number of alternatives in given Weighted Preference Lists that are not in List of Spoilers. If the level-indicator is more than the number of alternatives in supplied Weighted Preference Lists excluding those that are in spoilers list minus 2, the process is concluded.

Some embodiments of this invention also conclude the creation of said List of Spoilers in step 609 if at least one of, but not limited to, the following happens: the level-indicator is more than a predetermined level, a deadline has reached or a predetermined number of spoilers are found.

In step 615, a new combination of alternatives, in supplied Weighted Preference Lists, is selected based on a strategy. This combination is a set of alternatives wherein the number of alternatives in the set is the level-indicator. The selected combination does not include Strong Alternative or simple or compound spoilers in the List of Spoilers. Some embodiments choose some optimization strategies to maximize the speed of decision making by choosing from a certain subset of alternatives when selecting the combinations or by selecting the alternatives with certain order or according to some algorithms.

In step 626, the highest ranked alternative is found using a copy of said supplied Weighted Preference Lists without the alternatives in selected combination. The method used for creating this ranked list must be identical to what has been used for finding the Strong Alternative.

In step 630, the highest ranked alternative and Strong Alternative are compared to see if they are different. If they are found different, in step 635, the combination that was selected is considered to be a spoiler and is added to the anticipated List of Spoilers (list 640).

In step 645, it is verified if all the valid combinations at the current value of level-indicator have been selected and tested for spoiler effect. The valid combination is a set of alternatives in the supplied Weighted Preference Lists wherein the number of alternatives in the combination is the level-indicator and the selected combination does not have the Strong Alternative or the members of List of Spoilers.

If all of the valid combinations at this level-indicator are not tested, the steps 615 and its next steps are repeated. If all of the valid combinations at this level-indicator are tested, in step 651, the level-indicator is Incremented by one and the step 609 and its next steps are repeated.

### Example 8

### An Embodiment of this Invention in the Election of the Most Popular Artist in Televised Shows

This example shows how the flowchart in FIG. 5a is used by some embodiments of this invention in the election of the most popular artist in televised shows.

Let's assume 4 artists have reached to the top 4 group and the audiences are asked to express their preferences about the four and they are allowed to express their preferences for less than all alternatives.

The percentages of identical preferences are shown in the listing below:

### Given WPL:

### 30 Ben>Cam>Daniel>Audrey

### 10 Ben>Cam

### 28 Audrey>Ben>Cam>Daniel

### 32 Daniel>Cam>Audrey>Ben

If runoff voting was used, Audrey wouldn't go to the next level of competition. However some embodiments of this invention will decide differently.

In process 100, in step 200, process 200, as explained in FIG. 5a, finds a preferred collective choice.

In step 201 of process 200, a replica of Weighted Preference Lists is created and in step 300 a Strong Alternative is found.

### Replica WPL:

### 30 Ben>Cam>Daniel>Audrey

### 10 Ben>Cam

### 28 Audrey>Ben>Cam>Daniel

### 32 Daniel>Cam>Audrey>Ben

In process 300 shown in FIG. 3b, an operational copy of Weighted Preference Lists is made:

### Operational Copy of WPL:

### 30 Ben>Cam>Daniel>Audrey

### 10 Ben>Cam

### 28 Audrey>Ben>Cam>Daniel

### 32 Daniel>Cam>Audrey>Ben

In step 305 more than one alternative in found in it.

In step 312 to 316, using only the first preferences, Ben is selected and in step 318 is removed from the operational copy of Weighted Preference Lists:

### Operational Copy of WPL Ben Removed:

### 30 Cam>Daniel>Audrey

### 10 Cam

### 28 Audrey>Cam>Daniel

### 32 Daniel>Cam>Audrey

In step 305 to 316, using only the first preferences, Cam is selected and in step 318 is removed from the operational copy of Weighted Preference Lists:

### Operational Copy of WPL Ben and Cam Removed:

### 30 Daniel>Audrey

### 28 Audrey>Daniel

### 32 Daniel>Audrey

In step 305 to 316, using only the first preferences, Daniel is selected and in step 318 is removed from the Operational copy of WPL Ben, Cam and Daniel removed:

### 30 Audrey

10

### 28 Audrey

### 32 Audrey

And step 305, Audrey is found the only remaining alternative. In 320 is decided that a ranked list is created and in step 321 Audrey is added to Ranked list of alternatives.
Ranked List of alternatives (322)=(Audrey)

In step 323, Audrey is erased from Weighted Preference Lists.

In step 324, lists are found non empty and step 302 is repeated creating a new Operational copy Weighted Preference Lists.

### Operational Copy of WPL Audrey Erased:

### 30 Ben>Cam>Daniel

### 10 Ben>Cam

### 28 Ben>Cam>Daniel

### 32 Daniel>Cam>Ben

Repeating steps 305 to 324, Daniel and Cam and Ben are added to Ranked List of alternatives:

Ranked List of alternatives (322)=(Ben>Cam>Daniel>Audrey)
until there is no more alternatives in the operational copy of Weighted Preference Lists and then in step 326 Ben is selected as the highest ranked alternative and process 300 ends. And step 300 in process 200, finds a Strong Alternative.

### Strong Alternative=(Ben)

In step 600, process 600, creates a list of the spoilers the detail of this process is described in the next example.

### List of Spoilers={Cam&Daniel}

The List of Spoilers contains a compound spoiler. In step 208, it is found that some spoilers are detected. In step 230, the members the compound spoiler, are removed from the replica of Weighted Preference Lists.

### Replica WPL Compound Spoiler Daniel and Cam Removed:

### 30 Ben>Audrey

### 10 Ben>Cam

### 28 Audrey>Ben

### 32 Audrey>Ben

In step 300, a Strong Alternative using replica is found:

### Strong Alternative: (Audrey)

In step 600 and 208 No spoilers are found and the process 200 in concluded with Audrey as the highest ranked alternative and in step 110, 130, and 150 of process 100 Audrey is added to the Independent Collective Choice Ordered List 140.

In step 160, Audrey is removed from given Weighted Preference Lists and in step 170 it is decided that in step 200 the next Independent Collective Choice should be found.

### Given WPL:

### 30 Ben>Cam>Daniel

### 10 Ben>Cam

### 28 Ben>Cam>Daniel

### 32 Daniel>Cam>Ben

Next round of process 200 will find Ben as the highest ranked alternative and in the next iterations Cam and then Daniel will be found as the next highest ranked alternatives.

The Independent Collective Choice Ordered List will be:

### Independent Collective Choice Ordered List=(Audrey>Ben>Cam>Daniel>

And the one alternative that should not go to the next round of competition he will be Daniel.

### Example 9

### An Embodiment of Process 600 in FIG. 6 Used in the Election of the Most Popular Artist in Televised Shows

This example shows how the flowchart in FIG. 5a can apply process 600 as explained in FIG. 6, in the election of the most popular artist in televised shows.

While process 200 is being performed, in step 300, as explained as part a previous example a Strong Alternative according to process 300 in FIG. 3b is found:

### Strong Alternative=(Ben)

The Strong Alternative and a replica of Weighted Preference Lists are supplied to process 600 as explained in FIG. 6.

### Supplied WPL:

### 30 Ben>Cam>Daniel>Audrey

### 10 Ben>Cam

### 28 Audrey>Ben>Cam>Daniel

### 32 Daniel>Cam>Audrey>Ben

In step 601, the level-indicator is set to 1 and in step 609, 615 is selected as the next step,

In step 615, from the one member combinations of the three candidates only Audrey, Daniel and Cam are valid because the Strong Alternative (Ben) is not considered a valid spoiler. For the first iteration, Daniel is selected.

In step 626, the highest ranked alternative in supplied Weighted Preference Lists excluding Daniel using the same method explained in FIG. 3b will be found.

### Supplied WPL Daniel Excluded:

### 30 Ben>Cam>Audrey

### 10 Ben>Cam

### 28 Audrey>Ben>Cam

### 32 Cam>Audrey>Ben

The highest ranked alternative=(Ben)

In step 630, the highest ranked alternative (Ben) and Strong Alternative: (Ben) are compared and it is found that the highest ranked is the same as Strong Alternative.

In step 645 it is found that a valid combination in this level that is Audrey and is not tested for spoiler effect yet. In step 615, from the one member combinations of the three candidates only Audrey and Cam are valid. For the next iteration Audrey is selected.

In step 626, the highest ranked alternative in supplied Weighted Preference Lists excluding Audrey using the same method explained in FIG. 3b will be found.

### Supplied WPL Audrey Excluded:

### 30 Ben>Cam>Daniel

### 10 Ben>Cam

### 28 Ben>Cam>Daniel

### 32 Daniel>Cam>Ben

The highest ranked alternative=(Ben)

In step 630, the highest ranked alternative (Ben) and Strong Alternative: (Ben) are compared and it is found that they are the same.

In step 645, it is found that a valid combination in this level that is Cam is not tested for spoiler effect yet. In step 615, from the one member combinations of the three candidates only Cam is valid. For the next iteration Cam is selected.

In step 626, the highest ranked alternative in supplied Weighted Preference Lists excluding Cam using the same method explained in FIG. 3b will be is found.

Supplied WPL without Cam:

### 30 Ben>Daniel>Audrey

### 10 Ben

### 28 Audrey>Ben>Daniel

### 32 Daniel>Audrey>Ben

The highest ranked alternative=(Ben)

In step 630, the highest ranked alternative (Ben) and Strong Alternative: (Ben) are compared and it is found that they are the same.

In step 645 it is found that all valid combinations in this level have been tested.

In step 651, the level-indicator is incremented to 2.

In step 609, it is found that the level-indicator (2) is not bigger than (4−2).

In step 615, from the 2 member combinations of the three candidates only Audrey&Cam, Audrey &Daniel and Cam&Daniel are valid because the Strong Alternative is not considered a valid spoiler. For the next iteration Cam&Daniel is selected.

In step 626, the highest ranked alternative in supplied Weighted Preference Lists excluding Cam&Daniel using the same method explained in FIG. 3b will be found.

### Supplied WPL Cam&Daniel Removed:

### 30 Ben>Audrey

### 10 Ben

### 28 Audrey>Ben

### 32 Audrey>Ben

Highest ranked alternative=(Audrey)

In step 630, the highest ranked alternative (Audrey) and Strong Alternative: (Ben) are compared and it is found that the highest ranked Alternative is not the same as Strong Alternative.

In step 635, Cam and Daniel are added to the List of Spoilers as a compound spoiler.

In step 645, it is found that not all valid combinations in this level have been tested. Then steps 615 to 645 are repeated two more times and it is found that the only spoilers are Cam and Daniel.

And then in step 651 the level-indicator is incremented to 3 and in step 609, It is found that the level-indicator (3) is not be bigger than (4−2) and process 600 is concluded with:

### List of Spoilers (640)={(Cam and Daniel)}

The next steps are described in the previous example.

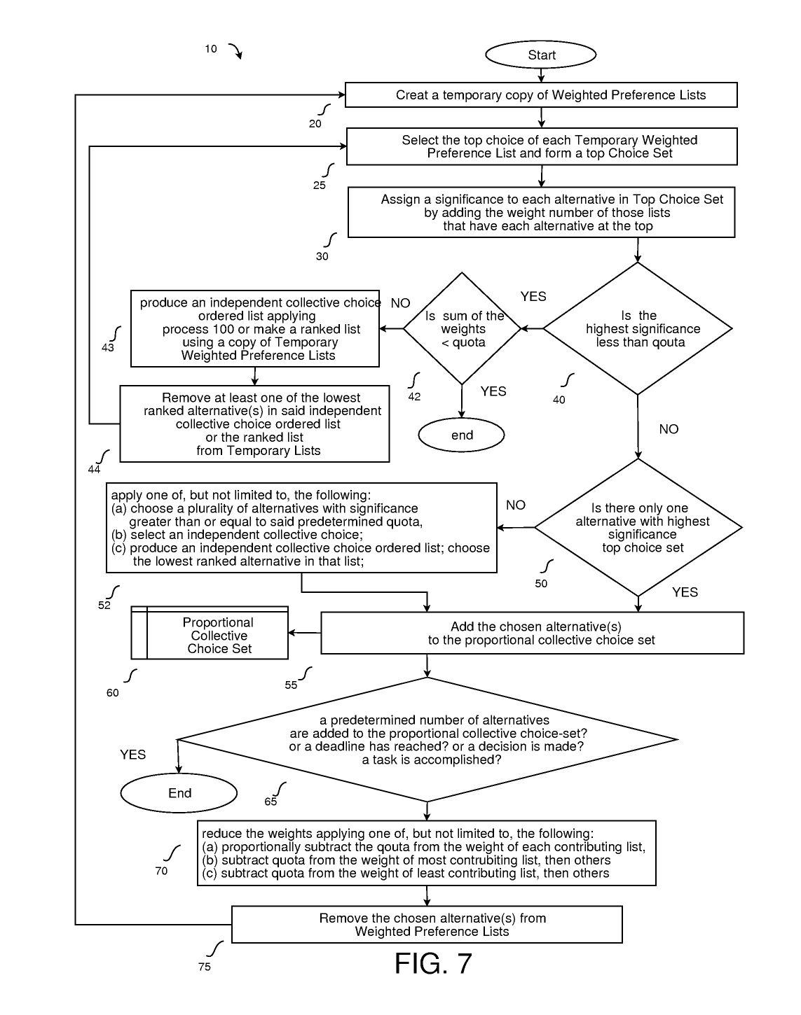

FIG. 7 is a flowchart showing the steps used in process 10 by some embodiments of this invention to select a collective choice set from alternatives in a set of Weighted Preference Lists with proportional representation.

In step 20, a temporary copy of Weighted Preference Lists is created;

In step 25, a “top choice set” consisting of the “top choice” of each list in said temporary Weighted Preference Lists is formed.

In step 30, a significance number is assigned to each alternative in said top choice set by adding the weight number of those temporary Weighted Preference Lists that have said alternative at the top. Some embodiments use other ways to combine the weight of each list and assign significance.

In step 40, the highest significance number and a predetermined quota are compared.

The quota is determined in relation with a predetermined number of alternatives that must be selected. Different embodiments of the invention can choose different strategies for selecting the quota for example, Droop quota or Hare quota. Some embodiments can choose a quota based on the following rule:

(Quota is a number greater than the sum of the weights of Weighted Preference Lists divided by a number that is “one more than the number of alternatives that should be selected”).

For example, if the sum of the weights of Weighted Preference Lists is 100 and three alternatives should be selected then the quota would be greater than 25; for example, 26.

If said highest significance number found in step 40 is less than a predetermined quota, in step 42, if sum of the weights of alternatives remaining in temporary Weighted Preference Lists is less than said quota, the process 10 in concluded and if this sum is greater than quota then step 43 is performed.

When step 43 and 44 should be performed, none of the alternatives has a significance level above the quota and therefore at least one of the alternatives must be selected to be removed from the lists. In an iterative loop of steps 43, 44,25,30,40 and 42, the lowest ranked alternative is determined and removed until at least one of the remaining alternatives goes above the predetermined quota.

In step 43, process 100 can be employed to produce an Independent Collective Choice Ordered List from a copy of said temporary Weighted Preference Lists. Embodiments of “Collaborative Plurality Method”, like process 100, have this advantage that they minimize the impact of introduction of the irrelevant alternatives. Some embodiments just use a collective choice procedure or step 300 to make a ranked list of alternatives.

Some embodiments of this invention find the alternatives that should be removed by limiting the search to Weighted Preference Lists including only the alternatives in said “top choice set” and employing process 100 to produce an Independent Collective Choice Ordered List from a copy of said temporary Weighted Preference Lists. Some embodiments choose to just use either a collective choice procedure, or apply a process 300 to make a ranked list of alternatives in Weighted Preference Lists including only the alternatives in said “top choice set”.

In step 44, at least one of the lowest ranked alternatives is removed from said temporary Weighted Preference Lists and then steps 25 and its next steps are repeated.

In step 40, if said highest significance number is greater than or equal to a predetermined quota, in step 50, the number of alternatives in top choice set that have that highest significance is verified. If there are more than one alternative with that same highest significance step 52 is performed and if there is only one alternative in top choice set that has that significance, step 55 is performed. Step 52 only happens when some alternatives in top choice set have exactly the same significance and tie with that highest significance above quota.

If there is only one alternative in top choice set that has that highest significance greater than or equal to a predetermined quota, in step 55, the chosen alternative which is the only alternative with that significance is added to the Proportional Collective Choice Set shown as list 60.

if said highest significance number is greater than or equal to a predetermined quota and a plurality of alternatives have said equal significance, in step 52, one or more alternatives among the alternatives with significance greater than or equal to quota are chosen and, in step 55, the chosen alternative or alternatives are added to the Proportional Collective Choice Set shown as list 60.

Different embodiments of this invention can choose different strategies for choosing among the alternatives that have tied with the highest significance number greater than or equal to a predetermined quota. Some can choose a plurality of said alternatives and some choose all of them, some employ process 100 to select an Independent Collective Choice using a copy of said temporary Weighted Preference Lists of only “the alternatives with significance number greater than or equal to said predetermined quota”, and some employ process 100 to produce an Independent Collective Choice Ordered List using said temporary Weighted Preference Lists of only “the alternatives with significance number greater than or equal to said predetermined quota” and then choose the lowest ranked alternative in said Independent Collective Choice Ordered List;

In step 65, some embodiments stop the process when some conditions apply. If a predetermined number of alternatives are added to the Proportional Collective Choice Set, the sum of the weights of remaining alternatives in Temporary copy of Weighted Preference Lists is less than said quota, a deadline has reached, a decision is made, a task is accomplished or other conditions are applicable, the process is concluded and the list 60 contains the Proportional Collective Choice Set.

If the above termination conditions are not satisfied, in step 70, the weights of lists in Weighted Preference Lists are reduced to reflect the selection of chosen alternatives. At this step the lists that had the chosen alternative at the top at step 25, will contribute from their weight to its selection. The sum of the contributions from different lists must be equal the predetermined quota. This step is easy to understand because it is similar to spending power to get something or spending money to buy goods. The evaluators with similar preference, who contribute to selection of an alternative, pay from the collective weight of that preference list. The embodiments of the invention that use “collaborative Plurality method” step 43 with this contribution approach can be called “Collaborative Proportional Contribution Methods”.

Different embodiments of this invention can choose different strategies for reducing the weights of lists in Weighted Preference Lists. Among all possible strategies, some proportionally subtract said quota from the weight currently assigned to Weighted Preference Lists contributing to the significance of each one of said chosen alternatives. Some subtract said quota from the weight currently assigned to Weighted Preference Lists with highest weight contributing to the significance of each one of said chosen alternatives equally, as much as they have weight, and then similarly subtracting the remainder of quota from the weight of the next highest weight contributing lists, and some subtract said quota from the weight currently assigned to Weighted Preference Lists with lowest weight contributing to the significance of each one of said chosen alternatives equally as much as they have weight, and then similarly subtracting the remainder of quota from the weight of the next lowest weight contributing lists.

In step 75, chosen alternatives are removed from Weighted Preference Lists and then step 20 is repeated.

In step 20, a new temporary copy of the Weighted Preference Lists is created. This means that all the not chosen alternatives are considered in the next round of selection for the next alternative. This is advantageous because the selection of each next alternative is treated as a new selection with adjusted weights that uses all of the information collected from evaluators. Then steps 25 and its next steps are repeated with the remaining alternatives in said set of Weighted Preference Lists to choose the next members of Proportional Collective Choice Set.

### Example 10

### An Embodiment of this Invention Used in Group Decision Support Systems with Proportional Representation in a Space Mission

Let's assume there are three astronauts in a space station and based on the data analyzed by experts there are six tasks that are suggested to be done as soon as possible. The tasks are: performing a space walk, installing new equipment, performing an astronomic observation, repairing a faulty tile, reporting some incidents, experiment with gravity. The astronauts can only perform three of those tasks in parallel in the available time. Based on their interpretation of the data and their knowledge, experts don't have consensus about which of the six tasks should be performed. In the Control Center, 100 scientists are deciding about the tasks that must be chosen and express their preferences which are aggregated to identical Weighted Preference Lists shown below:

### WPL:

40 space walk, install equipment, astronomic observation, repair, experiment, report,
27 space walk, install equipment, astronomic observation, repair, report, experiment
14 repair, experiment, space walk, install equipment, report, astronomic observation
19 report, space walk, install equipment, experiment
Notice that in this example 19 experts have not expressed all their preferences but process 10 can still be followed.

The group with the first preference have clear majority and if the decision was made based on majority (without proportionality), space walk, install equipment and astronomic observation would be performed. If the decision is made based on some collective choice system with proportional representation other decisions can be made.

For example, if some types of Single Transferable Vote (STV) is used the following can happen. Space walk and install equipment are chosen as two of the selections and are deleted from the lists and the points of the first list is adjusted and then repair is deleted from the list because it has the least first choices and then experiment is deleted from the lists because it has the least first choices and then “report” will be selected as the third choice.

The three alternatives selected in an embodiment of this invention would be different. Before starting process 10 to select a collective choice set from alternatives in a set of Weighted Preference Lists with proportional representation, a threshold based on the number alternatives being selected must be chosen. Different embodiments of this invention work with different thresholds; for this example, let's assume that a threshold according to droop quota is chosen to make guarantee that exactly three alternatives can be selected.

Predetermined number of selected alternatives=3, Quota=26

According to some embodiments of this invention shown in FIG. 7, process 10 starts with step 20.

In step 20, a temporary copy of Weighted Preference Lists is created:

### Temporary Copy of WPL:

40 space walk, install equipment, astronomic observation, repair, experiment, report,
27 space walk, install equipment, astronomic observation, repair, report, experiment
14 repair, experiment, space walk, install equipment, report, astronomic observation
19 report, space walk, install equipment, experiment

In step 25, the top choice of each Temporary Weighted Preference List is selected and a Top Choice Set is formed:

Top choice set={space walk, repair, report}

In step 30, by adding the weight number of those lists, a significance number is assigned to each alternative in Top Choice Set.

Top choice set={67 space walk, 14 repair, 19 report}

In step 40, it is verified that the highest significance number “67” is greater than the predetermined quota “26” and in step 50, it is found that there is only one alternative (space walk) with that significance.

In step 55, space walk is added to Proportional Collective Choice Set and one of the astronauts can be assigned to the task.

Proportional Collective Choice Set={space walk}

In step 65, it is found that not all of predetermined number of alternatives is selected.

In step 70, different embodiments choose different ways to calculate the contribution of each list to the selection of chosen alternative and to reduce the weight of those lists. In this embodiment the quota will be proportionally subtracted from the weights of first and second lists:

26*40/(40+27)=15.52 contribution of the first group to the selection of space walk
26*27(40+27)=10.48 contribution of the second group to the selection of space walk
Adjusted weight for the first preference list=40−15.52=24.48
Adjusted weight for the second preference list=27−10.48=16.52

In step 75, space walk is removed from the Weighted Preference Lists resulting:

### Adjusted WPL:

24.48 install equipment, astronomic observation, repair, experiment, report,
16.52 install equipment, astronomic observation, repair, report, experiment
14 repair, experiment, install equipment, report, astronomic observation
19 report, install equipment, experiment

In the calculations shown above there is no rounding necessary and the level of rounding is just limited to the precession of the calculating device or person. In the description below the numbers are rounded for readability. In step 20, a temporary copy of Weighted Preference Lists is created:

### Temporary Copy of WPL:

24.48 install equipment, astronomic observation, repair, experiment, report,
16.52 install equipment, astronomic observation, repair, report, experiment
14 repair, experiment, install equipment, report, astronomic observation
19 report, install equipment, experiment

In step 25, the top choice of each Temporary Weighted Preference List is selected and a top Choice Set is formed:

Top choice set={install equipment, repair, report}

In step 30, by adding the weight number of those lists, a significance number is assigned to each alternative in Top Choice Set.

Top choice set={41 space walk, 14 repair, 19 report}

In step 40, it is understood that the highest significance number “41” is greater than the quota “26” and in step 50 it is found that there is only one alternative with that significance. In step 55, “install equipment” is added to Proportional Collective Choice Set and one of the astronauts can be assigned to the task.

Proportional Collective Choice Set={space walk, install equipment}

In step 65 it is understood that not all of predetermined number of alternatives are selected. In step 70, in this embodiment the quota will be proportionally subtracted from the weights of contributing Weight Preference Lists:

26*24.48/(24.48+16.52)=15.53 contribution of the first group to the selection of space walk
26*16.52/(24.48+16.52)=10.47 contribution of the second group to the selection of space walk
And in step 75, install equipment is removed from the Weighted Preference Lists resulting:

### Adjusted WPL:

8.97 astronomic observation, repair, experiment, report,
6.03 astronomic observation, repair, report, experiment
14 repair, experiment, report, astronomic observation
19 report

In step 20, a temporary copy of Weighted Preference Lists is created:

### Temporary Copy of WPL:

8.97 astronomic observation, repair, experiment, report,
6.03 astronomic observation, repair, report, experiment
14 repair, experiment, report, astronomic observation
19 report

In step 25, the top choice of each Temporary Weighted Preference List is selected and a top Choice Set is formed:

Top choice set={astronomic observation, repair, report}

In step 30, by adding the weight number of those lists, a significance number is assigned to each alternative in Top Choice Set.

Top choice set={15 astronomic observation, 14 repair, 19 report}

In step 40, it is understood that the highest significance number is NOT greater than 26. And in step 42, it is found that the sum of the weights is 48 and is greater than quota. In step 43, process 100 is employed to produce an Independent Collective Choice Ordered List using a copy of Weighted Preference Listing including the alternatives in said temporary copy of WPL. Process 100 employing Process 200, as in FIG. 2a, using process 300 explained in FIG. 3b finds that that the Strong Alternative is report.

Strong Alternative=(report)

Process 400 explained in FIG. 4 using plurality as collective choice procedure will find that although “astronomic observation” is not the selected choice its removal will change the highest ranked alternative and the Ranked list of Alternatives without “astronomic observation” is

Ranked list of Alternatives=(repair>report)

This means that “astronomic observation” is a spoiler. It is signed out in step 230 and this will result the first Independent Collective choice selected in process 100 to be “repair” and the repetition in process will result:

Independent Collective Choice Ordered List: (repair>report>astronomic observation, experiment)

In step 44, “experiment” that is the lowest ranked alternative in Independent Collective Choice red List is removed from temporary copy of Weighted Preference Lists:

### Temporary Copy of WPL:

8.9 astronomic observation, repair, report
6 astronomic observation, repair, report
14 repair, report, astronomic observation
19 report
But it doesn't change the situation in top choice set; therefore, steps 25,30, 40 and 42 will lead to:
Top choice set={15 astronomic observation, 14 repair, 19 report}
And production of another Independent Collective Choice Ordered List in step 43 where “astronomic observation” is still found as spoiler results:
Independent Collective Choice Ordered List: (repair>report>astronomic observation)

In step 44, “astronomic observation” the lowest ranked alternative in Independent Collective Choice red List is removed from temporary copy of Weighted Preference Lists:

### Temporary Copy of WPL:

8.9 repair, experiment, report,
6 repair, report, experiment
14 repair, experiment, report
19 report

In step 25, the top choice of each Temporary Weighted Preference List is selected and a top Choice Set is formed:

Top choice set={repair, report}

In step 30, by adding the weight number of those lists, a significance number is assigned to each alternative in Top Choice Set.

Top choice set={29 repair, 19 report}

In step 40, it is understood that the highest significance number is greater than 26. In step 55, repair is added to Proportional Collective Choice Set and one of the astronauts can be assigned to this task.

Proportional Collective Choice Set={space walk, install equipment, repair}

In step 65, it verified that all three predetermined number of alternatives are selected and the process is concluded.

### Example 11

### An Embodiment of this Invention Used in Automated Control Systems that Make Decisions Based on the Measurements of Sensors

In this example, it is shown how some embodiments of this invention can be used in automated control systems that make decisions based on the measurement signals that come from sensors.

12 microprocessor based control units are monitoring a process. There are 4 possible alternative actions (ABCD) that can be performed in response to the current measurements of sensors.

The central control system receives the suggested feedback action from the microprocessor based control units and aggregates the results as Weighted Preference Lists and must choose one action to be performed as a result of limitations of the single robotic hand it is equipped with. However, when the measurements are processed by microprocessor based control units they decide that they are indifferent to some of the alternative actions:

### Given WPL:

### 5 (BD)>C

### 4 C>A>(BD)

### 3 A>B

The microprocessor based control units are allowed to suggest multiple action as the same priority actions. In the example above, 5 units have suggested that Actions B and D have the highest priority and should be done at the same time. Also microprocessor based control units can be silent about some alternatives as the first group has not rated action A.

A similar situation may arise in elections if people may be allowed to express indifference comparing two or more candidates while ranking them against the rest of candidates; for example, in voting for the members of their party when they want to give the same priority to all the candidates from their party.

In step 200 of process 100, process 200 is employed.

In step 201 of process 200 in FIG. 5a, a replica of Weighted Preference Lists is created.

### WPL1:

### 5 (BD)>C

### 4 C>A>(BD)

### 3 A>B

In step 300, using process 300 in FIG. 3b using plurality a Strong Alternative is found.

In step 312, the first choices are selected. In step 314, an aggregated weight is assigned to each first choice.

First choice alternatives=(5 B, 5 D, 4 C, 3 A)

In step 316, one of the alternatives should be selected but B and D are in tie situation. In some embodiments the process 200 is recursively employed to choose between tied alternatives except if they are found in a symmetric tie which can be broken with using a different collective choice rule or random selection. In this situation, considering only B and D in the Weighted Preference Lists, B is preferred over D. This means that the preferences of other evaluators influence the break of the tie.

So B is removed in step 318 and the resulting Ranked list of alternatives and the Strong Alternative found by process 200 with above strategy will be:

### Strong Alternative: (B)

In step 400, it will be found that C is a spoiler since the ranked list of alternatives without it, made by same process 300 has a different highest ranked alternative than the Strong Alternative.

Ranked List of alternatives without C: (A>B>D)

Therefore in step 435 C is added to List of Spoilers:

### List of Spoilers: {C}

In step 230, C is removed Weighted Preference Lists, and in step 300 and 400 a new Strong Alternative without spoilers will be found:

### Strong Alternative: (A)

And when 400 tests the Weighted Preference Lists without (C) it finds no more spoilers therefore “Action A” will be selected as highest ranking alternative and in step 110 it will be chosen as the Independent Collective Choice.

### CONCLUSION, RAMIFICATIONS, AND SCOPE

The group decisions and elections can be negatively affected by the possibility of vote splitting and spoiler effect, and may result in undesired outcomes. The embodiments of this invention avert the impact of introduction of the irrelevant alternatives that have no chance to be elected and enable the evaluators to express their sincere preferences and reduce the interest in tactical voting; at the same time, they lead to more reliable group decisions. The embodiments of this invention in control systems and machine decision making result in better and more stable decisions because they select the alternatives after the impact of spoilers are restricted. They process the preferences expressed by evaluators and avert the impact of spoilers during a decision making process. In some embodiments of this invention, determining a collective choice is treated as information processing and data mining task. The embodiments of this invention solve many problems observed in single winner election systems and embodiments for proportional representation, as described in some of the examples in description section, solve the problems many multi member electoral systems have been facing.

Before the preferences are expressed assuming which alternatives are spoilers, may hinder the purpose of collective decision making or freedom of expression; however, after the preferences of alternatives is known, the embodiments of this invention search and find the spoilers to cancel the dependencies on irrelevant alternatives.

The embodiments of this invention when used in elections are not only averting the impact of irrelevant alternatives on the collective choice but also can prevent situations when the sincere expressions of preferences by the evaluators become self defeating. The groups of people who prefer an alternative will have consent for temporary exclusion of their higher preference in favor of their next choices in each round of decision-making, if their higher preference can not be elected based on the collective choice procedure applied.

Thus the reader will see that methods described herein have the potential to materially enhance many collective decision making processes used in teams, in groups, in boards of directors, shareholder assemblies and in parliaments, electing the candidates and as well as many collective decisions in human made systems, for example automatic control systems, hardware equipment, networking and routing devices, system software, application software or embedded programs in hardware devices.

While the above description contains many specificities, these should not be construed as limitations on the scope of the invention, but rather an exemplification of some of the preferred embodiments thereof. Many other variations are possible, the embodiments of this invention can be, among many others, in means, apparatuses, and software programs or embedded programs in hardware devices where a decision on a number of alternatives based on a plurality of inputs are made. For example, any of the methods explained can be implemented in mobile devices to provide groups of people portable and reliable group decision making capabilities, or routers can use the methods of this invention to choose the best route for packets based on the preferences they collect from other network devices, or some embodiments can use the methods of this invention in aggregation used in weather forecasting based on measurements and preferences by sensors or experts in more consistent way. The embodiments can include implementation of methods of this invention in any vote collecting, manual or automatic tallying, counting or electoral and voting systems like different types of Mixed Member Proportional representation voting systems or Party-list proportional representation systems and Single Transferable Vote.

It is to be understood, that even though numerous characteristics and advantages of the present invention have been set forth in the foregoing description, together with details of the structure and function of the invention, the disclosure is illustrative only, and many embodiments of this invention can be made by changes in detail, especially in matters of arrangement of processes, and way of performing recursive tasks iteratively or repetitive tasks recursively, passing the lists from one process to the other by reference or by value, as well as embodiment in software, hardware, or a combination of both, within the principles of the invention to the full extent indicated by the broad general meaning of the terms in which the appended claims are expressed.

Accordingly, the scope of the invention should be determined not by the embodiments illustrated, but by the appended claims and their legal equivalents.

I claim:

1. A method for making collective decisions, using a given set of weighted preference lists, comprising the steps of:
(a) finding a preferred collective choice using given weighted preference lists while restricting the impact of spoilers and considering said choice as an independent collective choice;
(b) if an ordered list of independent collective choices should be produced, adding said independent collective choice as the next choice to the desired independent collective choice ordered list for given weighted preference lists, otherwise, concluding the decision process with said independent collective choice as decision outcome;
(c) if more alternatives should be selected performing the following steps:
(i.) deleting said independent collective choice from said given weighted preference lists;
(ii.) repeating steps (a) to (c) until at least one of, but not limited to, the following happens:
a predetermined number of collective preferences are selected,
a deadline has passed,
a decision is made,
a task is accomplished,
all the alternatives have been deleted from said given weighted preference lists.

2. The method in claim 1, further comprising the following step at the beginning of the process before step (a):
if the weight of one of the lists in given weighted preference lists, is greater than half of the total sum of weights of said given weighted preference lists, considering said list as the independent collective choice ordered list and its top choice as the independent collective choice and concluding the process, otherwise, continuing with step (a).

3. The method in claim 1, wherein finding a preferred collective choice using given weighted preference lists while restricting the impact of spoilers comprises the steps of:
(a) finding a highest ranked alternative, called strong alternative, using a copy of said given weighted preference lists excluding the spoilers signed in this process;
(b) creating a new list of spoilers using said given weighted preference lists excluding the spoilers signed in this process;
(c) if no spoilers are in the list of spoilers performing the following steps:
(i.) clearing the signs added in this process to said given weighted preference lists;
(ii.) concluding this process with the desired preferred collective choice being the last strong alternative just found in step (a);
(d) if any spoiler is in said list of spoilers, signing at least one spoiler out of said given weighted preference lists;
(e) repeating steps (a) to (e).

4. The method in claim 3, wherein finding a highest ranked alternative and making a ranked list of alternatives using provided copy of weighted preference lists comprise applying one or more methods selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method.

5. The method in claim 3, wherein finding a highest ranked alternative using a provided copy of weighted preference lists comprises the steps of:
(a) finding a remaining alternative by repeatedly removing the highest ranked alternative by repeatedly applying a collective choice procedure;
(b) erasing said remaining alternative from said provided weighted preference lists;
(c) repeating steps (a) to (c) until said provided copy of weighted preference lists has no alternatives;
(d) Considering the last alternative erased as the highest ranked alternative.

6. The method in claim 5, wherein finding a remaining alternative by repeatedly removing the highest ranked alternative by applying a collective choice procedure comprises:
(a) making an operational copy of provided weighted preference lists;
(b) repeating the following steps until there is only one alternative, remaining alternative, in said operational copy of weighted preference lists:
(i.) finding the highest ranked alternative in said operational copy of weighted preference lists by applying a collective choice procedure selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method;
(ii.) removing said highest ranked alternative from said operational copy of weighted preference lists;

7. The method in claim 5, wherein finding a remaining alternative by repeatedly removing the highest ranked alternative by applying a collective choice procedure comprises:
(a) making an operational copy of provided weighted preference lists;
(b) repeating the following steps until there is only one alternative, remaining alternative, in said operational copy of weighted preference lists:
(i.) selecting the first choice of each preference list in said operational copy of weighted preference lists;
(ii.) for each first choice selected, summing the weight of said weighted preference lists that have said first choice;
(iii.) selecting the alternative with the highest aggregated weight among said first choices;
(iv.) removing said highest ranked alternative from said operational copy of weighted preference lists.

8. The method in claim 5, further comprising a step to make a ranked list of alternatives performing the following after step (a):
adding said remaining alternative, as the highest ranked alternative so far, to the intended ranked list of alternatives.

9. The method in claim 3, wherein creating a new list of spoilers comprises the steps of:
(a) setting a level-indicator to 1;
(b) concluding the creation of said list of spoilers if at least one of, but not limited to, the following happens:
(i.) the level-indicator is greater than “the number of alternatives in given weighted preference lists, that are not signed” minus 2,
(ii.) the level indicator is more than a predetermined level,
(iii.) a deadline has reached;
(c) selecting a new combination of alternatives, from alternatives in “given weighted preference lists excluding: the signed alternatives, said strong alternative, spoilers and spoiler combinations in list of spoilers”, wherein the number of alternatives in the combination is the value of level-indicator;
(d) finding the highest ranked alternative using a copy of said given weighted preference lists without said selected combination of alternatives and without signed alternatives, by applying the same technique used in finding said strong alternative;
(e) if the highest ranked alternative found in step (d) is different than said strong alternative, adding said combination to the anticipated list of spoilers;
(f) If all valid combinations of alternatives at said level-indicator have not been tested, repeating the steps (c) to (f);
(g) incrementing said level-indicator by one;
(h) repeating steps (b) to (h).

10. The method in claim 3, wherein signing at least one spoiler out of said given weighted preference lists comprises the steps of:
(a) creating a sorted list of spoilers by applying one of methods selected from the group consisting of but not limited to:
(i.) recursively employing said steps of claim 1 to produce an independent collective choice ordered list using a copy of said given weighted preference lists including only the alternatives in said list of spoilers, and
(ii.) making a ranked list of alternatives using a copy of said given weighted preference lists including only the alternatives in said list of spoilers;
(b) signing the spoilers out of said given weighted preference lists by performing one or more methods selected from the group consisting of but not limited to:
(i.) signing at least one of spoilers in the list of spoilers out of said given weighted preference lists,
(ii.) signing the lowest ranked alternative in said sorted list of spoilers out of said given weighted preference lists,
(iii.) signing the alternatives of a combination that one of the members of the combination is the lowest ranked alternative in said sorted list of spoilers out of said given weighted preference lists, and
(iv.) signing a plurality of spoilers in said sorted list of spoilers out of said given weighted preference lists.

11. The method in claim 1, wherein finding a preferred collective choice using given weighted preference lists while restricting the impact of spoilers comprises the steps of:
(a) creating a replica of given weighted preference lists;
(b) finding a highest ranked alternative, called strong alternative, using a copy of said replica of weighted preference lists;
(c) creating a new list of spoilers using said replica of weighted preference lists;
(d) if no spoilers are in the list of spoilers concluding this process with the desired preferred collective choice being the last strong alternative just found in step (b);
(e) if any spoiler is in said list of spoilers, removing at least one spoiler out of said replica of weighted preference lists;
(f) repeating steps (b) to (f);

12. The method in claim 11, wherein finding a highest ranked alternative and making a ranked list of alternatives using provided copy of weighted preference lists comprise applying one or more methods selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method.

13. The method in claim 11, wherein finding a highest ranked alternative using a provided copy of weighted preference lists comprises the steps of:
(a) finding a remaining alternative by repeatedly removing the highest ranked alternative by applying a collective choice procedure;
(b) erasing said remaining alternative from said provided weighted preference lists;
(c) repeating steps (a) to (c) until said provided copy of weighted preference lists has no alternatives;
(d) Considering the last alternative erased as the highest ranked alternative.

14. The method in claim 13, wherein finding a remaining alternative by repeatedly removing the highest ranked alternative by applying a collective choice procedure comprises:
(a) making an operational copy of provided weighted preference lists;
(b) repeating the following steps until there is only one alternative, remaining alternative, in said operational copy of weighted preference lists:
(i.) finding the highest ranked alternative in said operational copy of weighted preference lists by applying a collective choice procedure selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method;
(ii.) removing said highest ranked alternative from said operational copy of weighted preference lists;

15. The method in claim 13, wherein finding a remaining alternative by repeatedly removing the highest ranked alternative by applying a collective choice procedure comprises:
(a) making an operational copy of provided weighted preference lists;
(b) repeating the following steps until there is only one alternative, remaining alternative, in said operational copy of weighted preference lists:
(i.) selecting the first choice of each preference list in said operational copy of weighted preference lists;
(ii.) for each first choice selected, summing the weight of said weighted preference lists that have said first choice;
(iii.) selecting the alternative with the highest aggregated weight among said first choices;
(iv.) removing said highest ranked alternative from said operational copy of weighted preference lists.

16. The method in claim 13, further comprising a step to make a ranked list of alternatives performing the following after step (a):
adding said remaining alternative, as the highest ranked alternative so far, to the intended ranked list of alternatives.

17. The method in claim 11, wherein creating a new list of spoilers comprises the steps of:
(a) setting a level-indicator to 1;
(b) concluding the creation of said list of spoilers if at least one of, but not limited to, the following happens:
(i.) the level-indicator is greater than “the number of alternatives in supplied weighted preference lists” minus 2,
(ii.) the level indicator is more than a predetermined level,
(iii.) a deadline has reached;
(c) selecting a new combination of alternatives, from alternatives in “supplied weighted preference lists excluding said strong alternative, spoilers, and spoiler combinations in list of spoilers”, wherein the number of alternatives in the combination is the value of level-indicator;
(d) finding the highest ranked alternative using a copy of said supplied weighted preference lists without said selected combination of alternatives, by applying the same technique used in finding said strong alternative;
(e) if the highest ranked alternative found in step (d) is different than said strong alternative, adding said combination to the anticipated list of spoilers;
(f) If all valid combinations of alternatives at said level-indicator have not been tested, repeating the steps (c) to (f);
(g) incrementing said level-indicator by one;
(h) repeating steps (b) to (h).

18. The method in claim 11, wherein removing at least one spoiler out of said replica of weighted preference lists comprises the steps of:
(a) creating a sorted list of spoilers by applying one of methods selected from the group consisting of but not limited to:
(i.) recursively employing said steps of claim 1 to produce an independent collective choice ordered list using a copy of said weighted preference lists including only the alternatives in said list of spoilers, and
(ii.) making a ranked list of alternatives using a copy of weighted preference lists including only the alternatives in said list of spoilers;
(b) removing the spoilers out of said replica of weighted preference lists by performing one or more methods selected from the group consisting of but not limited to:
(i.) removing at least one of spoilers in the list of spoilers out of said replica of weighted preference lists,
(ii.) removing the lowest ranked alternative in said sorted list of spoilers out of said replica of weighted preference lists,
(iii.) removing the alternatives of a combination that one of the members of the combination is the lowest ranked alternative in said sorted list of spoilers out of said replica of weighted preference lists, and
(iv.) removing a plurality of spoilers in said sorted list of spoilers out of said replica of weighted preference lists.

19. The method in claim 1, wherein each weighted preference list comprises:
(a) a ranked list of a set of alternatives comprising at least one of, but not limited to, the following:
(i.) a grouping of identical preferences of a plurality of evaluators about a set of sorted or scored alternatives wherein the number of alternatives in a list may be equal or different from other lists and said evaluators can be a plurality of humans, non-human means of evaluation, and mix of humans with non-humans,
(ii.) a ranking of preferences by an evaluator about a set of sorted or scored alternatives wherein the number of alternatives in a list may be equal or different from other lists and said evaluators comprises a plurality of: humans, non-human means of evaluation, and mix of humans with non-humans;
(b) a weight which is a number assigned to said weighted preference list wherein said number is the presentation of at least one of, but not limited to, the following:
(i.) count, vote count, frequency, relative frequency of evaluators having same said preference,
(ii.) power, privilege, trust, significance, confidence, reliability, expertise of evaluators with same said preference,
(iii.) result of combining the count, vote count, frequency, relative frequency and the power, privilege, trust, significance, confidence, reliability, expertise of evaluators with same preference.

20. The method in claim 1, wherein an alternative is one of, but is not limited to, the following: a value, a candidate or person, an opinion, a prediction, an attribute, an option, a behavior, a category, an advertisement, an entertainment selection, a document, place, a product, a thing or information, an action to be performed, a set of values, a range of numeric values, a group of attributes, a classification of objects, a category, a set of measurements, a future behaviors, a set of future behaviors, a set of options, a set of predictions, a set of candidates, a set of products, a set of objects, a set of solutions for problems, a set of observations, a set of controllable parameters, and a set of data collected from a group of sensors or their combinations.

21. The method of claim 1, used in selecting a collective choice set with proportional representation from alternatives in a set of weighted preference lists comprising the steps of:
(a) creating a temporary copy of said weighted preference lists;
(b) forming a top choice set consisting of the top choice of each temporary weighted preference list;
(c) assigning a significance number to each alternative in said top choice set by adding the weight number of those temporary weighted preference lists that have said alternative at the top;
(d) if said highest significance number is less than a predetermined quota, further comprising the steps of:
(i.) concluding this process if sum of the weights of alternatives remaining in said temporary weighted preference lists is less than said quota;
(ii.) finding lowest ranked alternatives by performing one of the following steps, selected from the group consisting of but not limited to:
I. employing said steps of claim 1 to produce an independent collective choice ordered list using a copy of said temporary weighted preference lists;
II. making a ranked list of alternatives by applying a collective choice procedure using a copy of said temporary weighted preference lists;
III. employing said steps of claim 1 to produce an independent collective choice ordered list using a copy of said temporary weighted preference lists including only the alternatives in said top choice set;
IV. making a ranked list of alternatives by applying a collective choice procedure using a copy of said temporary weighted preference lists including only the alternatives in said top choice set;
(iii.) removing at least one of the lowest ranked alternatives;
(iv.) repeating steps (b) to (d);
(e) if said highest significance number is greater than or equal to a predetermined quota and there is a unique highest ranked alternative, adding chosen alternative to the proportional collective choice set;
(f) if said highest significance number is greater than or equal to a predetermined quota and a plurality of alternatives have said equal significance, further comprising the steps of:
(i.) choosing among alternatives with significance greater than or equal to quota;
(ii.) adding chosen alternatives to intended proportional collective choice set;
(g) concluding this process if at least one of, but not limited to, the following happens:
sum of the weights of remaining alternatives in said temporary copy of
weighted preference lists is less than said quota,
a predetermined number of alternatives are added to the proportional
collective choice set,
a deadline has reached,
a decision is made,
a task is accomplished;
(h) reducing the weights of said weighted preference lists;
(i) removing said chosen alternatives from the weighted preference lists;
(j) repeating steps (a) to (j).

22. The method in claim 21, wherein choosing among alternatives with significance greater than or equal to quota comprises one of, but not limited to, the following:
(a) choosing a plurality of alternatives with significance number greater than or equal to said predetermined quota,
(b) selecting an independent collective choice employing said steps of claim 1 using said temporary weighted preference lists of only “the alternatives with significance number greater than or equal to said predetermined quota”,
(c) choosing the lowest ranked alternative in an independent collective choice ordered list produced by employing said steps of claim 1 using said temporary weighted preference lists of only “the alternatives with significance number greater than or equal to said predetermined quota”.

23. The method in claim 21, wherein reducing the weights of said weighted preference lists comprises one of, but not limited to, the following:
(a) proportionally subtracting said quota from the weight currently assigned to weighted preference lists contributing to the significance of each one of said chosen alternatives,
(b) subtracting said quota from the weight currently assigned to weighted preference lists with highest weight contributing to the significance of each one of said chosen alternatives equally as much as they have weight, and then similarly subtracting the remainder of quota from the weight of the next highest weight contributing lists,
(c) subtracting said quota from the weight currently assigned to weighted preference lists with lowest weight contributing to the significance of each one of said chosen alternatives equally as much as they have weight, and then similarly subtracting the remainder of quota from the weight of the next lowest weight contributing lists.

24. The method in claim 3, wherein ties in selecting the highest ranked alternative and selecting the lowest ranked alternative, are resolved using one or more methods selected from the group consisting of but not limited to:
(a) using a pair wise comparison if the tie is between two alternatives,
(b) using a method of making a ranked list of alternatives, with a collective choice procedure other than the one resulted the tie, to create a ranked list of tied alternatives using weighted preference lists that resulted the tie with only the alternatives in tie just to resolve the tie,
(c) using a method of making a ranked list of alternatives, with a collective choice procedure other than the one resulted the tie, to create a ranked list of alternatives that tied using weighted preference lists that resulted the tie,
(d) randomly selecting one of the tied alternatives,
(e) selecting a plurality of the tied alternatives.

25. A method for selecting a collective choice set with proportional representation from alternatives in a set of weighted preference lists comprising the steps of:
(a) creating a temporary copy of said weighted preference lists;
(b) forming a top choice set consisting of the top choice of each temporary weighted preference list;
(c) assigning a significance number to each alternative in said top choice set by adding the weight number of those temporary weighted preference lists that have said alternative at the top;
(d) if said highest significance number is less than a predetermined quota, further comprising the steps of:
(i.) concluding this process if sum of the weights of alternatives remaining in said temporary weighted preference lists is less than said quota;
(ii.) finding lowest ranked alternatives by performing one of the following steps, selected from the group consisting of but not limited to:
I. producing an independent collective choice ordered list using a copy of said temporary weighted preference lists;
II. making a ranked list of alternatives by applying a collective choice procedure using a copy of said temporary weighted preference lists;
III. producing an independent collective choice ordered list using a copy of said temporary weighted preference lists including only the alternatives in said top choice set;
IV. making a ranked list of alternatives by applying a collective choice procedure using a copy of said temporary weighted preference lists including only the alternatives in said top choice set;
(iii.) removing at least one of the lowest ranked alternatives;
(iv.) repeating steps (b) to (d);
(e) if said highest significance number is greater than or equal to a predetermined quota and there is a unique highest ranked alternative, adding chosen alternative to the proportional collective choice set;
(f) if said highest significance number is greater than or equal to a predetermined quota and a plurality of alternatives have said equal significance, further comprising the steps of:
(i.) choosing among alternatives with significance greater than or equal to quota;
(ii.) adding chosen alternatives to intended proportional collective choice set;
(g) concluding this process if at least one of, but not limited to, the following happens:
sum of the weights of remaining alternatives in said temporary copy of
weighted preference lists is less than said quota,
a predetermined number of alternatives are added to the proportional collective choice set,
a deadline has reached,
a decision is made,
a task is accomplished;
(h) reducing the weights of said weighted preference lists;
(i) removing said chosen alternatives from the weighted preference lists;
(j) repeating steps (a) to (j).

26. The method in claim 25, wherein choosing among alternatives with significance greater than or equal to quota comprises one of, but not limited to, the following:
(d) choosing a plurality of alternatives with significance number greater than or equal to said predetermined quota,
(e) selecting an independent collective choice using said temporary weighted preference lists of only “the alternatives with significance number greater than or equal to said predetermined quota”,
(f) producing an independent collective choice ordered list using said temporary weighted preference lists of only “the alternatives with significance number greater than or equal to said predetermined quota” choosing the lowest ranked alternative is said independent collective choice ordered list.

27. The method in claim 25, wherein reducing the weights of said weighted preference lists comprises one of, but not limited to, the following:
(d) proportionally subtracting said quota from the weight currently assigned to weighted preference lists contributing to the significance of each one of said chosen alternatives,
(e) subtracting said quota from the weight currently assigned to weighted preference lists with highest weight contributing to the significance of each one of said chosen alternatives equally as much as they have weight, and then similarly subtracting the remainder of quota from the weight of the next highest weight contributing lists,
(f) subtracting said quota from the weight currently assigned to weighted preference lists with lowest weight contributing to the significance of each one of said chosen alternatives equally as much as they have weight, and then similarly subtracting the remainder of quota from the weight of the next lowest weight contributing lists.

28. The method in claim 25, wherein selecting an independent collective choice and producing a independent collective choice ordered list using a given set of weighted preference lists, comprise the steps of:
(a) finding a preferred collective choice using given weighted preference lists while restricting the impact of spoilers and considering said choice as an independent collective choice;
(b) if an ordered list of independent collective choices should be produced, adding said independent collective choice as the next choice to the desired independent collective choice ordered list for given weighted preference lists, otherwise, concluding the decision process with said independent collective choice as decision outcome;
(c) if more alternatives should be selected performing the following steps:
(i.) deleting said independent collective choice from said given weighted preference lists;
repeating steps (a) to (c) until all the alternatives have been deleted from said given weighted preference lists.

29. The method in claim 28, further comprising the following step at the beginning of the process before step (a):
if the weight of one of the lists in given weighted preference lists, is greater than half of the total sum of weights of said given weighted preference lists, considering said list as the independent collective choice ordered list and its top choice as the independent collective choice and concluding the process, otherwise, continuing with step (a).

30. The method in claim 28, wherein finding a preferred collective choice using given weighted preference lists while restricting the impact of spoilers comprises the steps of:
(a) finding a highest ranked alternative, called strong alternative, using a copy of said given weighted preference lists excluding the spoilers signed in this process;
(b) creating a new list of spoilers using said given weighted preference lists excluding the spoilers signed in this process;
(c) if no spoilers are in the list of spoilers performing the following steps:
(i.) clearing the signs added in this process to said given weighted preference lists;
(ii.) concluding this process with the desired preferred collective choice being the last strong alternative just found in step (a);
(d) if any spoiler is in said list of spoilers, signing at least one spoiler out of said given weighted preference lists;
(e) repeating steps (a) to (e).

31. The method in claim 30, wherein creating a new list of spoilers comprises the steps of:
(a) setting a level-indicator to 1;
(b) concluding the creation of said list of spoilers if at least one of, but not limited to, the following happens:
(i.) the level-indicator is greater than “the number of alternatives in given weighted preference lists, that are not signed” minus 2,
(ii.) the level indicator is more than a predetermined level,
(iii.) a deadline has reached;
(c) selecting a new combination of alternatives, from alternatives in “given weighted preference lists excluding: the signed alternatives, said strong alternative, spoilers and spoiler combinations in list of spoilers”, wherein the number of alternatives in the combination is the value of level-indicator;
(d) finding the highest ranked alternative using a copy of said given weighted preference lists without said selected combination of alternatives and without signed alternatives, by applying the same technique used in finding said strong alternative;
(e) if the highest ranked alternative found in step (d) is different than said strong alternative, adding said combination to the anticipated list of spoilers;
(f) If all valid combinations of alternatives at said level-indicator have not been tested, repeating the steps (c) to (f);
(g) incrementing said level-indicator by one;
(h) repeating steps (b) to (h).

32. The method in claim 30, wherein signing at least one spoiler out of said given weighted preference lists comprises the steps of:
(a) creating a sorted list of spoilers by applying one of methods selected from the group consisting of but not limited to:
(i.) recursively employing said steps of claim 28 to produce an independent collective choice ordered list using a copy of said given weighted preference lists including only the alternatives in said list of spoilers, and
(ii.) making a ranked list of alternatives using a copy of said given weighted preference lists including only the alternatives in said list of spoilers;
(b) signing the spoilers out of said given weighted preference lists by performing one or more methods selected from the group consisting of but not limited to:
(i.) signing at least one of spoilers in the list of spoilers out of said given weighted preference lists,
(ii.) signing the lowest ranked alternative in said sorted list of spoilers out of said given weighted preference lists,
(iii.) signing the alternatives of a combination that one of the members of the combination is the lowest ranked alternative in said sorted list of spoilers out of said given weighted preference lists, and
(iv.) signing a plurality of spoilers in said sorted list of spoilers out of said given weighted preference lists.

33. The method in claim 28, wherein finding a preferred collective choice using given weighted preference lists while restricting the impact of spoilers comprises the steps of:
(a) creating a replica of given weighted preference lists;
(b) finding a highest ranked alternative, called strong alternative, using a copy of said replica of weighted preference lists;
(c) creating a new list of spoilers using said replica of weighted preference lists;
(d) if no spoilers are in the list of spoilers concluding this process with the desired preferred collective choice being the last strong alternative just found in step (b);
(e) if any spoiler is in said list of spoilers, removing at least one spoiler out of said replica of weighted preference lists;
(f) repeating steps (b) to (f);

34. The method in claim 33, wherein creating a new list of spoilers comprises the steps of:
(a) setting a level-indicator to 1;
(b) concluding the creation of said list of spoilers if at least one of, but not limited to, the following happens:
(i.) the level-indicator is greater than “the number of alternatives in supplied weighted preference lists” minus 2,
(ii.) the level indicator is more than a predetermined level,
(iii.) a deadline has reached;
(c) selecting a new combination of alternatives, from alternatives in “supplied weighted preference lists excluding said strong alternative, spoilers and spoiler combinations in list of spoilers”, wherein the number of alternatives in the combination is the value of level-indicator;
(d) finding the highest ranked alternative using a copy of said supplied weighted preference lists without said selected combination of alternatives, by applying the same technique used in finding said strong alternative;
(e) if the highest ranked alternative found in step (d) is different than said strong alternative, adding said combination to the anticipated list of spoilers;
(f) If all valid combinations of alternatives at said level-indicator have not been tested, repeating the steps (c) to (f);
(g) incrementing said level-indicator by one;
(h) repeating steps (b) to (h).

35. The method in claim 33, wherein removing at least one spoiler out of said replica of weighted preference lists comprises the steps of:
(a) creating a sorted list of spoilers by applying one of methods selected from the group consisting of but not limited to:
(i.) recursively employing said steps of claim 28 to produce an independent collective choice ordered list using a copy of said weighted preference lists including only the alternatives in said list of spoilers, and
(ii.) making a ranked list of alternatives using a copy of weighted preference lists including only the alternatives in said list of spoilers;
(b) removing the spoilers out of said replica of weighted preference lists by performing one or more methods selected from the group consisting of but not limited to:
(i.) removing at least one of spoilers in the list of spoilers out of said replica of weighted preference lists,
(ii.) removing the lowest ranked alternative in said sorted list of spoilers out of said replica of weighted preference lists,
(iii.) removing the alternatives of a combination that one of the members of the combination is the lowest ranked alternative in said sorted list of spoilers out of said replica of weighted preference lists, and
(iv.) removing a plurality of spoilers in said sorted list of spoilers out of said replica of weighted preference lists.

36. The method in claim 25, wherein finding a highest ranked alternative and making a ranked list of alternatives using provided copy of weighted preference lists comprise applying one or more methods selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method.

37. The method in claim 25, wherein finding a highest ranked alternative using a provided copy of weighted preference lists comprises the steps of:
(a) finding a remaining alternative by repeatedly removing the highest ranked alternative by applying a collective choice procedure;
(b) erasing said remaining alternative from said provided weighted preference lists;
(c) repeating steps (a) to (c) until said provided copy of weighted preference lists has no alternatives.
(d) Considering the last alternative erased as the highest ranked alternative.

38. The method in claim 37, wherein finding a remaining alternative by repeatedly removing the highest ranked alternative by applying a collective choice procedure comprises:
(a) making an operational copy of provided weighted preference lists;
(b) repeating the following steps until there is only one alternative, remaining alternative, in said operational copy of weighted preference lists:
(i.) finding the highest ranked alternative in said operational copy of weighted preference lists by applying a collective choice procedure selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method;
(ii.) removing said highest ranked alternative from said operational copy of weighted preference lists;

39. The method in claim 37, wherein finding a remaining alternative by repeatedly removing the highest ranked alternative by applying a collective choice procedure comprises:
(a) making an operational copy of provided weighted preference lists;
(b) repeating the following steps until there is only one alternative, remaining alternative, in said operational copy of weighted preference lists:
(i.) selecting the first choice of each preference list in said operational copy of weighted preference lists;
(ii.) for each first choice selected, summing the weight of said weighted preference lists that have said first choice;
(iii.) selecting the alternative with the highest aggregated weight among said first choices;
(iv.) removing said highest ranked alternative from said operational copy of weighted preference lists.

40. The method in claim 37, further comprising a step to make a ranked list of alternatives performing the following after step (a):
adding said remaining alternative, as the highest ranked alternative so far, to the intended ranked list of alternatives.

41. The method in claim 25, wherein each weighted preference list comprises:
(a) a ranked list of a set of alternatives comprising at least one of, but not limited to, the following:
(i.) a grouping of identical preferences of a plurality of evaluators about a set of sorted or scored alternatives wherein the number of alternatives in a list may be equal or different from other lists and said evaluators can be a plurality of humans, non-human means of evaluation, and mix of humans with non-humans,
(ii.) a ranking of preferences by an evaluator about a set of sorted or scored alternatives wherein the number of alternatives in a list may be equal or different from other lists and said evaluators comprises a plurality of: humans, non-human means of evaluation, and mix of humans with non-humans;
(b) a weight which is a number assigned to said weighted preference list wherein said number is the presentation of at least one of, but not limited to, the following:
(i.) count, vote count, frequency, relative frequency of evaluators having same said preference,
(ii.) power, privilege, trust, significance, confidence, reliability, expertise of evaluators with same said preference,
(iii.) result of combining the count, vote count, frequency, relative frequency and the power, privilege, trust, significance, confidence, reliability, expertise of evaluators with same preference.

42. The method in claim 25, wherein an alternative is one of, but is not limited to, the following: a value, a candidate or person, an opinion, a prediction, an attribute, an option, a behavior, a category, an advertisement, an entertainment selection, a document, place, a product, a thing or information, an action to be performed, a set of values, a range of numeric values, a group of attributes, a classification of objects, a category, a set of measurements, a future behaviors, a set of future behaviors, a set of options, a set of predictions, a set of candidates, a set of products, a set of objects, a set of solutions for problems, a set of observations, a set of controllable parameters, and a set of data collected from a group of sensors or their combinations.

43. A method for finding the highest ranked alternative using a provided set of weighted preference lists by repeatedly choosing the highest ranking alternative comprising the steps of:
(a) finding a remaining alternative by repeatedly removing the highest ranked alternative by applying a collective choice procedure;
(b) erasing said remaining ranked alternative from said provided weighted preference lists;
(c) If a collective choice set should be selected and said provided copy of weighted preference lists has a predetermined number of alternatives, considering them as the collective choice set;
(d) repeating steps (a) to (e) until said provided copy of weighted preference lists has no remaining alternatives;
(e) Considering the last alternative erased as the highest ranked alternative.

44. The method in claim 43, wherein finding a remaining alternative by repeatedly removing the highest ranked alternative by applying a collective choice procedure comprises:
(a) making an operational copy of provided weighted preference lists;
(b) repeating the following steps until there is only one alternative, remaining alternative, in said operational copy of weighted preference lists:
(i.) finding the highest ranked alternative in said operational copy of weighted preference lists by applying a collective choice procedure selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method;
(ii.) removing said highest ranked alternative from said operational copy of weighted preference lists;

45. The method in claim 43, wherein finding a remaining alternative by repeatedly removing the highest ranked alternative by applying a collective choice procedure comprises:
(a) repeating the following steps until there is only one alternative in said operational copy of weighted preference lists:
(i.) finding the highest ranked alternative in said operational copy of weighted preference lists by applying a collective choice procedure selected from the group consisting of but not limited to: a Nanson's method, a Baldwin method, a Ranked Pairs method, a Coombs' method, a Schulze method, a Kemeny-Young method, a Condorcet scoring method, a Borda Count method, a Copeland's method, a rating summation method, and a plurality method;
(ii.) temporarily removing said highest ranked alternative from said operational copy of weighted preference lists;
(b) considering the one remaining alternative as the outcome;
(c) re-including all the temporarily removed alternatives in said weighted preference lists;

46. The method in claim 43, wherein finding a remaining alternative by repeatedly removing the highest ranked alternative by applying a collective choice procedure comprises:
(a) making an operational copy of provided weighted preference lists;
(b) repeating the following steps until there is only one alternative, remaining alternative, in said operational copy of weighted preference lists:
(i.) selecting the first choice of each preference list in said operational copy of weighted preference lists;
(ii.) for each first choice selected, summing the weight of said weighted preference lists that have said first choice;
(iii.) selecting the alternative with the highest aggregated weight among said first choices;
(iv.) removing said highest ranked alternative from said operational copy of weighted preference lists.

47. The method in claim 43, further comprising a step to make a ranked list of alternatives comprising the following step after step (b):
adding said remaining alternative, as the highest ranked alternative so far, to the intended ranked list of alternatives.

48. A method for, finding spoilers in a set weighted preference lists comprising the steps of:
(a) finding a highest ranked alternative called strong alternative using said weighted preference lists;
(b) setting a level-indicator to 1;
(c) concluding the creation of said list of spoilers if at least one of, but not limited to, the following happens:
(i.) the level-indicator is greater than “the number of alternatives in weighted preference lists” minus 2,
(ii.) the level indicator is more than a predetermined level,
(iii.) a deadline has reached;
(d) selecting a new combination of alternatives, from alternatives in “said weighted preference lists excluding said strong alternative, spoilers and spoiler combinations in list of spoilers”, wherein the number of alternatives in the combination is the value of level-indicator;
(e) finding the highest ranked alternative using a copy of said given weighted preference lists without said selected combination of alternatives, by applying the same technique used in finding said strong alternative;
(f) if the highest ranked alternative found in step (e) is different than said strong alternative, adding said combination to the anticipated list of spoilers;
(g) If all valid combinations of alternatives at said level-indicator have not been tested, repeating the steps (d) to (g);
(h) incrementing said level-indicator by one;
(i) repeating steps (c) to (i).
